(19) United States
(12) Patent Application Publication
(10) Pub. No.: US 2022/0229183 A1
(43) Pub. Date: Jul. 21, 2022

(54) LiDAR INTEGRATED WITH SMART HEADLIGHT AND METHOD

(71) Applicant: Optonomous Technologies, Inc., Agoura Hills, CA (US)

(72) Inventors: Yung Peng Chang, Hsinchu (TW); Kenneth Li, Agoura Hills, CA (US); Mark Chang, Taichung (TW); Andy Chen, Taichung (TW); Wood-Hi Cheng, Taichung (TW); Chun-Nien Liu, Taichung (TW); Zing-Way Pei, Taichung (TW)

(21) Appl. No.: 17/613,916

(22) PCT Filed: May 24, 2020
(86) PCT No.: PCT/US2020/034447

§ 371 Date: Nov. 23, 2021

Related U.S. Application Data
(60) Provisional application No. 62/950,080, filed on Dec. 18, 2019.
(60) Provisional application No. 62/857,662, filed on Jun. 5, 2019.
(60) Provisional application No. 62/853,538, filed on May 28, 2019.

(51) Int. Cl. G01S 17/86; G01S 7/481; G01S 17/89; G01S 7/484; G02B 26/08

(52) U.S. Cl. CPC G01S 17/86; G01S 7/4817; G02B 26/0833; G01S 7/484; G01S 17/89

(57) ABSTRACT

A system and method using a single-minor micro-electro-mechanical system (MEMS) two-dimensional (2D) scanning mirror assembly, and/or a digital micromirror device (DMD having a plurality of independently steerable minors) for steering a plurality of light beams that include one or more light beam(s) for the headlight beam(s) of a vehicle and/or one or more light beam(s) for LiDAR purposes, along with highly effective associated devices for light-wavelength conversion, light dumping and heatsinking. Some embodiments include a digital camera, wherein image data from the digital camera and distance data from the LiDAR sensor are combined to provide information used to control the size, shape and direction of the smart headlight beam.

### CROSS-REFERENCE TO RELATED APPLICATIONS

This application claims priority benefit, including under 35 U.S.C. § 119(e), of
U.S. Provisional Patent Application No. 62/853,538, filed May 28, 2019 by Y. P. Chang et al., titled “LIDAR Integrated With Smart Headlight Using a Single DMD,”
U.S. Provisional Patent Application No. 62/857,662, filed Jun. 5, 2019 by Chun-Nien Liu et al., titled “Scheme of LIDAR-Embedded Smart Laser Headlight for Autonomous Driving,” and
U.S. Provisional Patent Application No. 62/950,080, filed Dec. 18, 2019 by Kenneth Li, titled “Integrated LIDAR and Smart Headlight using a Single MEMS Mirror,” each of which is incorporated herein by reference in its entirety.

This application is related to:
PCT Patent Application PCT/US2019/037231 titled “ILLUMINATION SYSTEM WITH HIGH INTENSITY OUTPUT MECHANISM AND METHOD OF OPERATION THEREOF”, filed Jun. 14, 2019, by Y. P. Chang et al. (published Jan. 16, 2020 as WO 2020/013952);
U.S. patent application Ser. No. 16/509,085 titled “ILLUMINATION SYSTEM WITH CRYSTAL PHOSPHOR MECHANISM AND METHOD OF OPERATION THEREOF”, filed Jul. 11, 2019, by Y. P. Chang et al. (published Jan. 23, 2020 as US 2020/0026169);
U.S. patent application Ser. No. 16/509,196 titled “ILLUMINATION SYSTEM WITH HIGH INTENSITY PROJECTION MECHANISM AND METHOD OF OPERATION THEREOF”, filed Jul. 11, 2019, by Y. P. Chang et al. (published Jan. 23, 2020 as US 2020/0026170);
U.S. Provisional Patent Application 62/837,077 titled “LASER EXCITED CRYSTAL PHOSPHOR SPHERE LIGHT SOURCE”, filed Apr. 22, 2019, by Kenneth Li et al.;
U.S. Provisional Patent Application 62/856,518 titled “VERTICAL CAVITY SURFACE EMITTING LASER USING DICHROIC REFLECTORS”, filed Jul. 8, 2019, by Kenneth Li et al.;
U.S. Provisional Patent Application 62/871,498 titled “LASER-EXCITED PHOSPHOR LIGHT SOURCE AND METHOD WITH LIGHT RECYCLING”, filed Jul. 8, 2019, by Kenneth Li;
U.S. Provisional Patent Application 62/873,171 titled “SPECKLE REDUCTION USING MOVING MIRRORS AND RETRO-REFLECTORS”, filed Jul. 11, 2019, by Kenneth Li;
U.S. Provisional Patent Application 62/862,549 titled “ENHANCEMENT OF LED INTENSITY PROFILE USING LASER EXCITATION”, filed Jun. 17, 2019, by Kenneth Li;
U.S. Provisional Patent Application 62/874,943 titled “ENHANCEMENT OF LED INTENSITY PROFILE USING LASER EXCITATION”, filed Jul. 16, 2019, by Kenneth Li;
U.S. Provisional Patent Application 62/881,927 titled “SYSTEM AND METHOD TO INCREASE BRIGHTNESS OF DIFFUSED LIGHT WITH FOCUSED RECYCLING”, filed Aug. 1, 2019, by Kenneth Li;
U.S. Provisional Patent Application 62/895,367 titled “INCREASED BRIGHTNESS OF DIFFUSED LIGHT WITH FOCUSED RECYCLING”, filed Sep. 3, 2019, by Kenneth Li; and
U.S. Provisional Patent Application 62/903,620 titled “RGB LASER LIGHT SOURCE FOR PROJECTION DISPLAYS”, filed Sep. 20, 2019, by Lion Wang et al.; each of which is incorporated herein by reference in its entirety.

### FIELD OF THE INVENTION

The present invention relates to the field of solid-state illumination and three-dimensional (3D) imaging and measurement, and more specifically to a system and method for using a single-mirror Micro-Electro-Mechanical System (MEMS) scanning mirror assembly, and/or a DMD (digital micromirror device) having a plurality of independently steerable mirrors or switchable-tilt mirrors for steering a plurality of light beams that include one or more light beam(s) for the headlight beam(s) of a vehicle and/or one or more light beam(s) for LiDAR purposes, along with highly effective associated devices for light-wavelength conversion, light dumping and heatsinking. Some embodiments include a digital camera, wherein image data from the digital camera and distance data from the LiDAR sensor are combined to provide information used to control the size, shape and direction of the smart headlight beam.

### BACKGROUND OF THE INVENTION

LiDAR stands for light detection and ranging (also laser imaging, detection and ranging). LiDAR has seen extensive use in autonomous vehicles, robotics, aerial mapping, and atmospheric measurements. LiDAR is one of the key sensors for autonomous driving. LiDAR sensors emit invisible laser-light beams to scan and detect objects in the near or far vicinity of the sensors and create a three-dimensional (3D) map of the surroundings environment [1-4] (numbers in square brackets herein refer to publications listed in Table 1 below (which is adapted from “New scheme of LiDAR-embedded smart laser headlight for autonomous vehicles,” Y-P. Chang et al., Optics Express Vol. 27, Issue 20, pp. A1481-A1489 (September, 2019))).

TABLE 1
References

1. B. Schwarz, “LiDAR: Mapping the world in 3D,” Nat. Photonics 4(7), 429-430 (2010).
2. C. V. Poulton, A. Yaacobi, D. B. Cole, M. J. Byrd, M. Raval, D. Vermeulen, and M. R.
Watts, “Coherent solid-state LiDAR with silicon photonic optical phased arrays,” Opt. Lett.
42(20), 4091-4094 (2017).
3. W. Xie, T. Komljenovic, J. Huang, M. Tran, M. Davenport, A. Torres, P. Pintus, and J. E.
Bowers, “Heterogeneous silicon photonics sensing for autonomous cars,” Opt. Express 27(3),
3642-3662 (2019).
4. L. Ulrich, “Whiter brights with lasers,” IEEE Spectrum 50(11), 36-56 (2013).
5. Leddar Vu8 Solid-State LiDAR, LeddarTech Inc., 4535 Wilfrid-Hamel Blvd, Suite 240,
Quebec City, QC, G1P 2J7 Canada.
6. J. Wang, C. C. Tsai, W. C. Cheng, M. H. Chen, C. H. Chung, and W. H. Cheng, “High
thermal stability of phosphor-converted white light-emitting diodes employing Ce:YAG-
doped glass,” IEEE J. Sel. Top. Quantum Electron. 17(3), 741-746 (2011).
7. Y. P. Chang, J. K. Chang, W. C. Cheng, Y. Y. Kuo, C. N. Liu, L. Y. Chen, and W. H.
Cheng, “New scheme of a highly-reliable glass-based color wheel for next-generation laser
light engine,” Opt. Mater. Express 7(3), 1029-1034 (2017).
8. Y. P. Chang, J. K. Chang, W. C. Cheng, Y. Y. Kuo, C. N. Liu, L. Y. Chen, and W. H.
Cheng, “An advanced laser headlight module employing highly reliable glass phosphor,” Opt.
Express 27(3), 1808 (2019).
9. Y. H. Kim, N. S. M. Viswanath, S. Unithrattil, H. J. Kim, and W. B. Im, “Review-
Phosphor Plates for High-Power LED Applications: Challenges and Opportunities toward
Perfect Lighting,” ECS J. Solid State Sci. Technol. 7(1), R3134-R3147 (2018).
10. Y. Peng, Y. Mou, H. Wang, Y. Zhuo, H. Li, M. Chen, and X. Luo, “Stable and efficient
all-inorganic color converter based on phosphor in tellurite glass for next-generation laser-
excited white lighting,” J. Eur. Ceram. Soc. 38(16), 5525-5532 (2018).
11. Y. Peng, Y. Mou, Y. Zhuo, H. Li, X. Z. Wang, M. X. Chen, and X. B. Luo, “Preparation
and luminescent performances of thermally stable red-emitting phosphor-in-glass for high-
power lighting,” J. Alloys Compd. 768(5), 114-121 (2018).
12. Y. Peng, Y. Mou, Q. Sun, H. Cheng, M. X. Chen, and X. B. Luo, “Facile fabrication of
heat-conducting phosphor-in-glass with dual-sapphire plates for laser-driven white lighting,”
J. Alloys Compd. 790(25), 744-749 (2019).
13. L. Wang, R. J. Xie, T. Suehiro, T. Takeda, and N. Hirosaki, “Down-conversion nitride
materials for solid State lighting: recent advances and perspectives,” Chem. Rev. 118(4),
1951-2009 (2018).
14. M. Cantore, N. Pfaff, R. M. Farrell, J. S. Speck, S. Nakamura, and S. P. DenBaars, “High
luminous flux from single crystal phosphor-converted laser-based white lighting system,”
Opt. Express 24(2), A215-A221 (2016).
15. K. Yoshimura, K. Annen, H. Fukunaga, M. Harada, M. Izumi, K. Takahashi, T.
Uchikoshi, R. J. Xie, and N. Hirosaki, “Optical properties of solid-state laser lighting devices
using SiAl on phosphor□glass composite films as wavelength converters,” Jpn. J. Appl. Phys.
55(4), 042102 (2016).
16. NVIDIA Jetson TX2, NVIDIA Corporation, Santa Barbara, California, USA

PCT Patent Application Publication WO 2020/013952 (of Application PCT/US2019/037231), which is incorporated by reference, describes an illumination system that includes a waveguide having a first end configured to receive a laser light, a luminescent portion configured to generate a luminescent light from the laser light, a second end opposite the first end configured to pass the luminescent light; an input device adjacent to the first end configured to collect the laser light for propagation to the first end; an output device adjacent to the second end configured to reflect at least some of the laser light back into the luminescent portion and direct the luminescent light away from the second end through an output surface. In one embodiment, the input device includes a light homogenizer configured to receive the laser light and provide to the first end of the waveguide a spatially uniform intensity distribution of the laser light. In another embodiment, a heat dissipater is provided adjacent to the waveguide and configured to dissipate heat generated within the waveguide by the generation of the luminescent light.

U.S. Patent Application Publication 2020/0026169 by Chang et al. published Jan. 23, 2020 with the title “Illumination system with crystal phosphor mechanism and method of operation thereof” (U.S. application Ser. No. 16/509,085), and is incorporated by reference. Patent Application Publication 2020/0026169 describes an illumination system that includes: a laser array assembly including: a laser configured to generate a laser light; a crystal phosphor waveguide, adjacent to the laser and in the laser light, configured to: generate of a luminescent light based on receiving the laser light, and direct the luminescent light away from a base end; and a compound parabolic concentrator (CPC), coupled to the crystal phosphor waveguide opposite the base end, configured to: collect the luminescent light from the crystal phosphor waveguide, extract the luminescent light away from the crystal phosphor waveguide.

U.S. Patent Application Publication 2020/0026170 by Chang et al. published Jan. 23, 2020 with the title “Illumination system with high intensity projection mechanism and method of operation thereof” (U.S. application Ser. No. 16/509,196), and is incorporated by reference. Patent Application Publication 2020/0026170 describes an illumination system that includes an input device configured to generate a first luminescent light beam; a pumping assembly, optically coupled to the input device, configured to project a pumping light beam into the input device; a focusing lens, aligned with the first luminescent light beam, to focus the first luminescent light beam enhanced by the pumping light beam as an output beam; and an output device, optically coupled to the focusing lens, configured to: receive the output beam from the focusing lens, and project an application output, formed with the output beam, from a projection device.

U.S. Pat. No. 5,727,108 to Hed issued on Mar. 10, 1998 with the title “High efficiency compound parabolic concentrators and optical fiber powered spot luminaire,” and is incorporated by reference. U.S. Pat. No. 5,727,108 describes a compound parabolic concentrator (CPC) that can be used as an optical connector or in a like management system or simply as a concentrator or even as a spotlight. That CPC has a hollow body formed with an input aperture and an output aperture and a wall connecting the input aperture with the output aperture and diverting from the smaller of the cross-sectional areas to the larger cross-sectional areas of the apertures. The wall is composed of contiguous elongated prisms of a transparent dielectric material so that the single reflection from the inlet aperture to the outlet aperture takes place within the prisms and thus the losses of purely reflective reflectors can be avoided.

A journal article titled “Optical efficiency study of PV Crossed Compound Parabolic Concentrator,” by Nazmi Sellami and Tapas K. Mallick (Applied Energy, February, 2013, Vol. 102, 868-876) (which is incorporated herein by reference), describes static solar concentrators that present a solution to the challenge of reducing the cost of Building Integrated Photovoltaic (BIPV) by reducing the area of solar cells. In this study a 3-D ray trace code has been developed using MATLAB in order to determine the theoretical optical efficiency and the optical flux distribution at the photovoltaic cell of a 3-D Crossed Compound Parabolic Concentrator (CCPC) for different incidence angles of light rays.

United States Patent Application Publication 2014/0373901 by Mallick et al. published on Dec. 25, 2014 with the title “Optical Concentrator and Associated Photovoltaic Devices”, and is incorporated by reference. Patent Application Publication 2014/0373901 describes a transmissive optical concentrator comprising an elliptical collector aperture and a non-elliptical exit aperture, the concentrator being operable to concentrate radiation incident on said collector aperture. The body of said concentrator may have a substantially hyperbolic external profile. Also disclosed is a photovoltaic cell employing such a concentrator and a photovoltaic building unit comprising an array of optical transmissive concentrators, each having an elliptical collector aperture; and an array of photovoltaic cells, each aligned with an exit aperture of a concentrator, wherein the area between adjacent collector apertures is transmissive to visible radiation.

There is a need in the art for an improved smart headlight and method, and a combined vehicle smart headlight and LiDAR system and method.

### SUMMARY OF THE INVENTION

In some embodiments, the present invention provides an apparatus that includes: a LiDAR device, the LiDAR device including: a laser that outputs a pulsed LiDAR laser signal; a DMD having a plurality of individually selectable mirrors arranged on a first major surface of the DMD; first optics configured to capture light from an entire scene and to focus the captured light to a focal plane located at the first surface of the DMD; a light detector; and a first light dump, wherein each respective one of the plurality of mirrors of the DMD is switchable to selectively reflect a respective portion of the captured light to one of a plurality of angles including a first angle that directs the reflected light toward the light detector and a second angle that directs the reflected light toward the first light dump.

In some embodiments, the present invention provides an apparatus for automatically adjusting a spatial shape of a vehicle headlight beam as projected onto a scene. This second apparatus includes: a first pump-light source that generates a first pump light (such as a pump laser and/or other pump-light source generating pump light from one or more LEDs (light-emitting diodes) or other sources of pump light); a first plate made of glass having a phosphor therein operatively coupled to receive the first pump light and to emit wavelength-converted light from areas of the glass first plate illuminated by the first pump light; projection optics operatively coupled to receive the wavelength-converted light from the first plate and an unconverted portion of the first pump light and configured to project a headlight beam toward the scene, wherein the headlight beam is based on the received wavelength-converted light and the unconverted portion of the first pump light; a digital imager configured to obtain image data of the scene; a LiDAR sensor configured to obtain a plurality of distance measurements of objects in the scene; and control logic operatively coupled to receive and combine the image data and the plurality of distance measurements and configured, based on the combined image data and distance measurements, to generate headlight-control data that is used to adjust the spatial shape of the headlight beam.

In some embodiments, the present invention provides an apparatus for vehicle-headlight illumination and LiDAR scanning a scene. This third apparatus includes: a first MEMS scanner that includes a first two-dimensional (2D) scanner mirror; a laser-phosphor smart headlight that includes: a first pump laser that outputs a first pump laser beam; and a target phosphor plate configured to receive the first pump laser beam and convert a wavelength of the first pump laser beam to a converted wavelength light; and a LiDAR laser system that includes: a pulsed LiDAR laser that outputs a pulsed LiDAR laser beam to be scanned across the scene, wherein the laser-phosphor smart headlight and the LiDAR laser system both use the first 2D scanner mirror to respectively reflect the first pump laser beam of the first pump laser along an optical path that impinges on a first area of the target phosphor plate and the pulsed LiDAR laser beam along an optical path towards the scene. Some such embodiments further include: a second pump laser that outputs a second pump laser beam, and wherein the target phosphor plate assembly is configured to receive the second pump laser beam on a second area of the target phosphor plate assembly and convert a wavelength of the second pump laser beam to a converted-wavelength light; and a projection lens located along an optical path between the target phosphor plate assembly and the scene, wherein the projection lens is configured to form a headlight beam that includes a portion of unconverted light of the first pump laser beam and converted wavelength light from the first area of the target phosphor plate assembly and a portion of unconverted light of the second pump laser beam and converted wavelength light from the second area of the target phosphor plate assembly.

### BRIEF DESCRIPTION OF THE DRAWINGS

FIG. 1 is a side-view schematic of a scene 100 with a full-field laser-illumination LiDAR system 101, according to some embodiments of the present invention.

FIG. 2A is a side-view schematic of a scene 200A with a partial-field-laser-illumination LiDAR system 201 rotated to point in a first direction, according to some embodiments of the present invention.

FIG. 2B is a side-view schematic of a scene 200B with a partial-field-laser-illumination LiDAR system 201 rotated to point in a second direction, according to some embodiments of the present invention.

FIG. 3 is a side-view schematic of a scene 300 with a scanned laser-illumination LiDAR system 301, according to some embodiments of the present invention.

FIG. 4 is a side-view schematic of a scene 400 with a scanned laser-illumination and scanned detection LiDAR system 401, according to some embodiments of the present invention.

FIG. 5A is a side-view schematic of a scene 500 with a combined headlight, scanned laser-illumination and scanned detection LiDAR system 501, according to some embodiments of the present invention.

FIG. 5B is a side-view schematic of a DMD-lens system 502 usable with system 501, according to some embodiments of the present invention.

FIG. 5C is a side-view schematic of an alternative DMD-lens system 503 usable with system 501, according to some embodiments of the present invention.

FIG. 6A is a side-view schematic of a scene 600 with full-field laser-illumination and scanned detection LiDAR system 601, according to some embodiments of the present invention.

FIG. 6B is a side-view schematic of a scene 600 with full-field laser-illumination and scanned detection LiDAR system 602, according to some embodiments of the present invention.

FIG. 7 is a perspective-view schematic of a combined smart headlight with scanned laser-pumped illumination and LiDAR system 701, according to some embodiments of the present invention.

FIG. 8 is a side-view schematic of a combined smart headlight with scanned laser-pumped illumination system 801, according to some embodiments of the present invention.

FIG. 9A is a schematic diagram of a ray-tracing simulation 900 of a smart headlight system 901, according to some embodiments of the present invention.

FIG. 9B is a schematic diagram of illumination intensity 902 from a smart headlight system 901, according to some embodiments of the present invention.

FIG. 10A is a cross-section side-view schematic diagram of a glass-phosphor wavelength-converting system 1001 usable for a smart headlight system, according to some embodiments of the present invention.

FIG. 10B is a schematic diagram of a smart headlight system 1002, according to some embodiments of the present invention.

FIG. 11A is a schematic diagram of a ray-tracing simulation 1101 of a smart headlight system 1002, according to some embodiments of the present invention.

FIG. 11B is a schematic diagram of illumination intensity 1102 from a smart headlight system 1002, according to some embodiments of the present invention.

FIG. 12A is a block diagram of a LiDAR system 1201, according to some embodiments of the present invention.

FIG. 12B is a schematic diagram of operation of a software system 1202, according to some embodiments of the present invention.

FIG. 13 is a block diagram of a headlight-control method and system 1301, according to some embodiments of the present invention.

FIG. 14A is a schematic block diagram of a region-of-interest (ROI) LiDAR system 1401, according to some embodiments of the present invention.

FIG. 14B is a schematic block diagram of ROI LiDAR system 1402, according to some embodiments of the present invention.

FIG. 15 is a perspective-view diagram of a two-dimensional MEMS mirror system 1501, according to some embodiments of the present invention.

FIG. 16 is a side-view diagram of a smart headlight with scanned laser-pumped illumination system 1601 that utilizes a two-dimensional MEMS mirror system 1501, according to some embodiments of the present invention.

FIG. 17A is a side-view diagram of a combined LiDAR and smart headlight with scanned laser-pumped illumination system 1701 that utilizes a two-dimensional MEMS mirror system 1501, according to some embodiments of the present invention.

FIG. 17B is a side-view diagram of a combined LiDAR and smart headlight with scanned laser-pumped illumination system 1702 that utilizes a two-dimensional MEMS mirror system 1501 but avoids redirection optics for the scanned LiDAR output beam, according to some embodiments of the present invention.

FIG. 17C is a side-view diagram of a combined LiDAR and smart headlight with scanned laser-pumped illumination system 1703 that utilizes a two-dimensional MEMS mirror system 1501 but avoids redirection optics for the scanned LiDAR output beam and includes a heatsink on the phosphor plate 1737, according to some embodiments of the present invention.

FIG. 18 is a side-view diagram of a combined LiDAR and smart headlight with scanned laser-pumped illumination system 1801 that utilizes a two-dimensional MEMS mirror system 1501, according to some embodiments of the present invention.

FIG. 19 is a side-view diagram of a combined low-beam/high-beam smart headlight with scanned laser-pumped illumination system 1901 that utilizes a two-dimensional MEMS mirror system 1501, according to some embodiments of the present invention.

FIG. 20A is a front-view diagram 2001 of a phosphor plate 2010 usable, for example, in combined low-beam/high-beam smart headlight with scanned laser-pumped illumination system 1901, according to some embodiments of the present invention.

FIG. 20B is a front-view diagram 2002 of a phosphor plate 2020 usable, for example, in combined low-beam/high-beam smart headlight with scanned laser-pumped illumination system 1901, according to some embodiments of the present invention.

FIG. 20C is a front-view diagram 2003 of a phosphor plate 2030 usable, for example, in combined low-beam/high-beam smart headlight with scanned laser-pumped illumination system 1901, according to some embodiments of the present invention.

FIG. 21 is a cross-section-view diagram of a phosphor plate 2101 usable, for example, in combined low-beam/high-beam smart headlight with scanned laser-pumped illumination systems such as 1601, 1701, 1702, 1703, 1801 or 1901, according to some embodiments of the present invention.

FIG. 22 is a cross-section-view diagram of a phosphor plate 2201 usable, for example, in combined low-beam/high-beam smart headlight with scanned laser-pumped illumination systems such as 1601, 1701, 1702, 1703, 1801 or 1901, according to some embodiments of the present invention.

FIG. 23 is a cross-section-view diagram of a phosphor plate assembly 2301 usable, for example, in combined low-beam/high-beam smart headlight with scanned laser-pumped illumination systems such as 1601, 1701, 1702, 1703, 1801 or 1901, according to some embodiments of the present invention.

### DESCRIPTION OF PREFERRED EMBODIMENTS OF PART A OF THE INVENTION

Although the following detailed description contains many specifics for the purpose of illustration, a person of ordinary skill in the art will appreciate that many variations and alterations to the following details are within the scope of the invention. Specific examples are used to illustrate particular embodiments; however, the invention described in the claims is not intended to be limited to only these examples, but rather includes the full scope of the attached claims. Accordingly, the following preferred embodiments of the invention are set forth without any loss of generality to, and without imposing limitations upon the claimed invention. Further, in the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. The embodiments shown in the Figures and described here may include features that are not included in all specific embodiments. A particular embodiment may include only a subset of all of the features described, or a particular embodiment may include all of the features described.

The leading digit(s) of reference numbers appearing in the Figures generally corresponds to the Figure number in which that component is first introduced, such that the same reference number is used throughout to refer to an identical component which appears in multiple Figures. Signals and connections may be referred to by the same reference number or label, and the actual meaning will be clear from its use in the context of the description.

Certain marks referenced herein may be common-law or registered trademarks of third parties affiliated or unaffiliated with the applicant or the assignee. Use of these marks is for providing an enabling disclosure by way of example and shall not be construed to limit the scope of the claimed subject matter to material associated with such marks.

One of the recent developments in automotive technology is LiDAR for autonomous vehicles. LiDAR provides the digital “vision” of the environment for controlling the various functions of the vehicle, including lighting, cruising, etc. However, today's LiDAR systems have difficulties in meeting the specifications of car manufacturers. Together with the desire to have a smart headlight, the total cost of conventional smart headlights and LiDAR becomes too high for mass adoption.

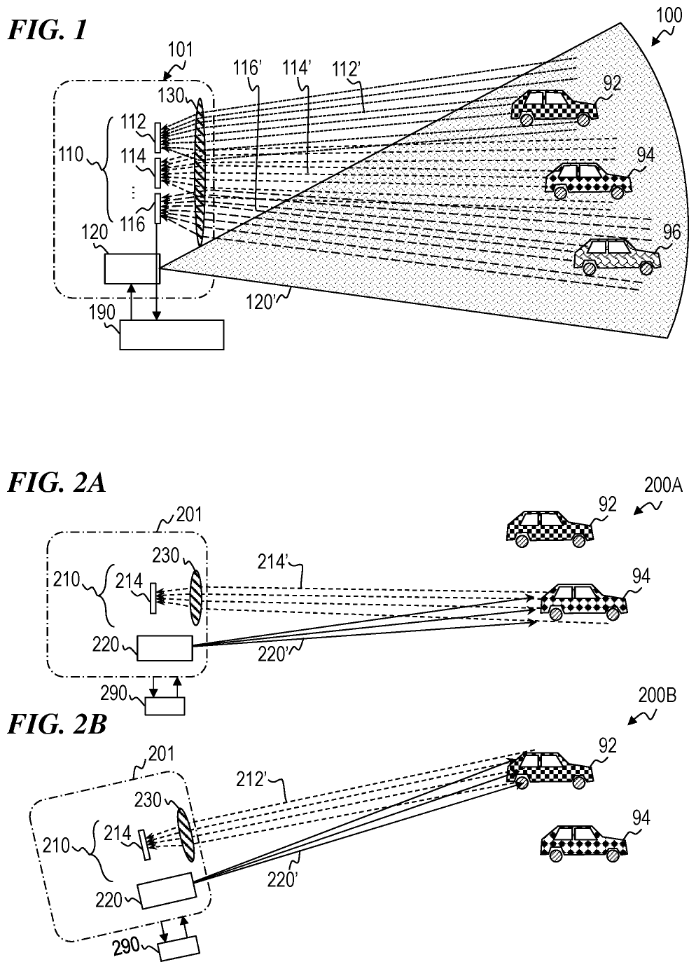

FIG. 1 is a side-view schematic of a scene 100 with a full-field laser-illumination LiDAR system 101, according to some embodiments of the present invention. In some embodiments, LiDAR system 101 includes a pulsed laser 120 that outputs a relatively wide-angle spread pulsed laser output beam 120′ that is used to illuminate the entire scene. In some embodiments, a detector system 110 includes a plurality of detectors 112, 114, . . . 116 arranged at the focal plane of lens system 130 (in some embodiments, the plurality of detectors 112, 114, . . . 116 are located at different various X and Y positions on an XY grid). The portion 112′ of the output beam 120′ that reflects from object 92 (e.g., in some embodiments, 112′ represents a pulsed light signal reflected by a car 92) through lens 130 is focused by lens 130 onto detector 112. The portion 114′ of the output beam 120′ that reflects from object 94 through lens 130 is focused onto detector 114. The portion 116′ of the output beam 120′ that reflects from object 96 through lens 130 is focused onto detector 116. In some embodiments, each pulse of the output beam 120′ passes through optics (e.g., a lens system) that spreads the beam to illuminate the entire full field of view such that the entire scene of interest is illuminated by the same single pulse for each set of distance measurements. In some embodiments, a processor 190 is operatively coupled to control operation of the components described above and/or receive signals from other components of system 101 to determine the distances to objects 92, 94, . . . 96 based on the time delays between each of the plurality of returning pulsed signals 112′, 114′, . . . 116′ relative to each single pulse of the pulsed output signal 120′.

FIG. 1 illustrates the basic function of a LiDAR system in which a pulsed laser beam 120′ is targeted at the scene 100 that has, in this example, three objects located at different distances and directions as shown, represented by three cars 92, 92 and 96. The detection sensor system 110 is represented by a plurality of (e.g., in some embodiments, three as shown here) respective detectors 112, 114, . . . 116, each receiving reflected signal from a respective one of the objects 92, 94, . . . 96. In some embodiments, the plurality of detectors 110 includes a larger number of detectors, since the number of distance measurements depends on the number of detectors, where here only three detectors are shown. The respective X-Y-location of each respective detector 112, 114, and 116 of the plurality of detectors 110 at the focal plane of lens 130 represents the corresponding respective X-Y-angles of the vector towards respective cars 92, 94, . . . 96 and the delay time between each output laser pulse 120′ and the respective detected pulse 112′, 114′, . . . 116′ is converted to distance (the radial distance of a polar coordinate system, sometimes called herein the Z distance), and this radial distance and the angular coordinates (sometimes referred to as polar angles φ and θ, or herein as the X-Y-angles since some embodiments steer the output laser beam using a mirror that tilts in the X and Y directions) are combined and converted to cartesian coordinates to determine the X-Y-Z-location of each object relative to LiDAR system 101, where one object location can be determined for each of the plurality of detectors 110 (one X-Y-Z location relative to LiDAR system 101 corresponding to each provided detector 112, 114, . . . 116 for each emitted pulse 120′). This allows the LiDAR system 101 to provide a three-dimensional (3D) digital picture of the environment.

FIG. 2A is a side-view schematic of a scene 200A with a partial-field-laser-illumination LiDAR system 201 rotated to point in a first direction at a first period in time, according to some embodiments of the present invention. In some embodiments, LiDAR system 201 includes a pulsed laser 220 that outputs a relatively narrow-angle pulsed laser output beam 220′ that is used to illuminate a small portion of the entire scene, and the pulsed reflected light 214′ is focused by lens 230 onto detector 214 of detection system 210. LiDAR system 201 is configured to rotate itself to point at different portions of scene 200A at sequential times. In some embodiments, the rotation allows LiDAR system 201 to point to different angles in the X and Y directions to determine distances and thus determine the X-Y-Z locations of objects in the scene 200A. In some embodiments, a processor 290 is operatively coupled to control operation of the components described above and/or receive signals from other components of system 201, in order to determine the distances to objects 94 and 92, respectively, based on the time delay between the returning pulsed signals 214′ and 212′, respectively, relative to the pulsed output signal 220′ during the respective first and second periods in time.

FIG. 2B is a side-view schematic of a scene 200B with a partial-field-laser-illumination LiDAR system 201 rotated to point in a second direction at a second period in time (e.g., scene 200B, which is the same as scene 200A, but at a later point in time), according to some embodiments of the present invention. Referring again to FIG. 2A, the portion 214′ (a pulsed light signal) of the output beam 220′ that reflects from object 94 (e.g., in some embodiments, a car) through lens 230 at the first point in time is focused by lens 230 onto detector 214. The portion 214′ of the output beam 220′ that reflects from object 94 through lens 230 is focused onto detector 214 during the first period in time. At the later period in time corresponding to scene 200B, the portion 212′ of the output beam 220′ that reflects from object 92 through lens 230 is focused onto detector 214 during the second period in time. In some embodiments, each pulse of the output beam 220′ passes through optics (e.g., a lens system, not shown) that focusses the beam to illuminate just a small portion of the field of view.

FIGS. 2A and 2B illustrate system 201 (one alternative to system 101 of FIG. 1) that uses a rotating platform, where the XY-location of the target is determined by the angle of rotation and/or tilt of the system 201 and/or an internal mirror. Again, the Z-location (the distance between system 201 and an object at which system 201 is pointed) is determined by the delay time between the respective detected pulse and the corresponding output pulse 220′ during a respective period of time.

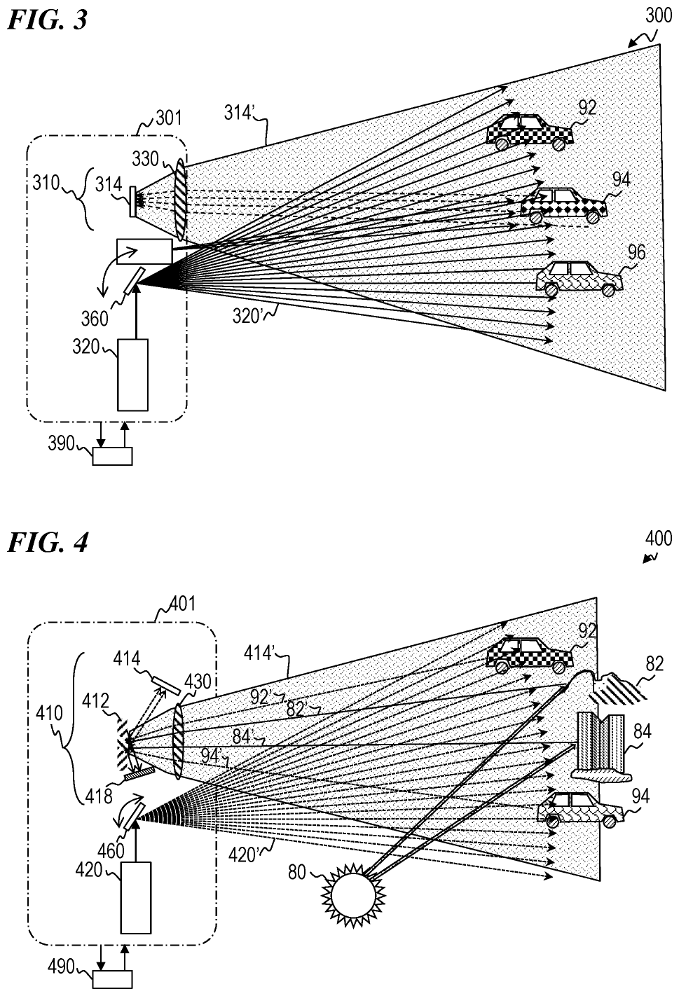

FIG. 3 is a side-view schematic of a scene 300 with a scanned laser-illumination LiDAR system 301, according to some embodiments of the present invention. In some embodiments, LiDAR system 301 includes a pulsed laser 320 that outputs a relatively narrow-angle pulsed laser output beam 320′ (in some embodiments, laser 320 is an infrared laser and pulsed laser output beam 320′ has an infrared wavelength) that is pointed in different X-Y directions by two-dimension (2D) scanning mirror 360 to illuminate a small portion of the entire scene, and the pulsed reflected light 314′ from that illuminated portion (as well as from the rest of scene 300) is focused by lens 330 onto stationary detector 314 of detection system 310. In some embodiments, there is only a single detector 314 that is used to determine the time delay between the output pulses from laser 320, which LiDAR system 301 is configured to point laser beam 320′ at different portions (different X and Y angles) of scene 300 at sequential times by tilting 2D scanning mirror 360. In some embodiments, the X and Y tilting of scanning mirror 360 allows LiDAR system 301 to sequentially point to different angles in the X and Y directions to determine distances between system 301 and the plurality of objects (e.g., cars 92, 94 and 96) and thus determine the X-Y-Z locations of a plurality of various objects in the scene 300. In some embodiments, because there is a single laser 320 and a single detector 314, each X and Y angle must be scanned sequentially, which takes more time to scan the entire scene than system 101 (which can use a single laser pulse 120′ from its laser 120 to determine distances to as many objects and/or directions as the number of detectors 110, but because the pulse is spread across the entire scene (beam 120′ is spread to a larger portion of a solid angle for each output pulse 120′ (e.g., a larger portion of a steradian)), each object in the scene reflects less power toward the detectors 112, 114, . . . 116). In contrast, the intensity of laser power in system 301 is higher at each object because the entire output pulse 320′ is pointed at only one, much smaller solid angle at a time. However, detector 314 of system 201 has a somewhat smaller signal-to-noise (S/N) ratio, as compared to system 401 of FIG. 4 described below, because detector 314 receives light from the entire scene 300, not just the portion illuminated by each of the pulses from scanned laser beam 320′. In some embodiments, a processor 390 is operatively coupled to control operation of the components described above and/or receive signals from other components of system 301, in order to determine distances to various objects in scene 300 and/or to generate a three-dimensional image or map of those objects.

Similar to FIG. 2, FIG. 3 shows a system 301 that uses a laser beam that is scanned across scene 300, using various types of laser-beam pointers or scanners (e.g., in some embodiments, a 2D scanning mirror 360 that is controlled to point in various directions to get the various angles needed for determining the XY-angles to the object or target). The Z distance is determined by the time-of-flight as described previously. In some embodiments, the X angle and Y angle are combined with the Z distance (e.g., using a polar coordinate system or geometry) to mathematically determine the X-Y-Z location relative to system 301 (e.g., in some embodiments, obtaining a cartesian coordinate system or geometry) of each object in scene 300.

FIG. 4 is a side-view schematic of a scene 400 with a scanned laser-illumination and scanned detection LiDAR system 401, according to some embodiments of the present invention. In some embodiments, LiDAR system 401 includes a pulsed laser 420 that outputs a relatively narrow-angle pulsed laser output beam 420′ that is pointed in different X-Y directions by 2D scanning output mirror 460 to illuminate a small portion of the entire scene. While reflected light 414′ from the entire scene 400 is focused by lens 430 onto DMD 412, the mirror(s) of DMD 412 on only a certain computer-selected area of DMD 412 are pointed to reflect light from those mirrors toward detector 414, while light toward all other areas of DMD 412 is reflected by mirrors of DMD 412 that are controlled to reflect that light toward light dump 418. In some embodiments, the pulsed reflected light 414′ from that illuminated portion is focused by lens 430 (e.g., in some embodiments, lens 430 being implemented as one or more lenses, and/or a hologram or other focusing optics) onto DMD array of mirrors 412 located at the focal plane of lens 430, one or more of which reflects light from just those angle(s) (or portion(s)) of scene 400, at which output laser beam 420′ is being directed at a given period of time, onto stationary detector 414 of detection system 410, while light from all other angle(s) (or portion(s)) of scene 400 is reflected towards light dump 418 (in some embodiments, a black surface that is highly absorbent to wavelengths of light from scene 400). In some embodiments, an aperture is provided around the light path toward light dump 418 and/or the light path toward detector 414 to prevent or reduce any stray reflections from light dump 418 from reaching detector 414. In some embodiments, there is only a single detector 414 that is used to determine the time delay between the scanned output pulses from laser 420. In some embodiments, LiDAR system 401 is configured to point output laser beam 420′ at different portions (different X and Y angles) of scene 400 at sequential times by tilting 2D scanning mirror 460, and to also tilt one or more of the mirrors of DMD 412 corresponding to the X-Y angles of output laser beam 420′, while all other mirrors of DMD 412 reflect light from those other portions of scene 400 to light dump 418. In some embodiments, the X and Y tilting of mirror 460 and the tilting of the mirrors of DMD 412 to reflect toward detector 414 for the portion of scene 400 being measured (and to reflect toward light dump 418 for all other portions of scene 400 to improve the S/N ratio) allows LiDAR system 401 to point output beam 420′ toward (and receive light to detector 414 from) different angles in the X and Y directions to determine Z-distances between system 401 and a plurality of objects (e.g., cars 92 . . . 94), and thus determine the X-Y-Z locations of various objects in the scene 400. Thus, during a first period of time, pulsed output laser beam 420′ points toward the X-Y angles corresponding to object 92 (e.g., a car), and the reflection 92′ of the output laser beam from object 92 is directed by one or a few mirrors of DMD 412 toward detector 414, while the background noise of reflections of light from sun 80 (e.g., reflections 82′ from snow on distant mountains 82 or reflections 84′ from glass windows of buildings 84 (or even sun reflections 94′ from other objects 94)) are reflected toward light dump 418 by other ones of the plurality of mirrors of DMD 412. Later, during a second period of time, pulsed output laser beam 420′ points toward the X-Y angles corresponding to object 94 (e.g., another car), and the reflection 94′ of the output laser beam from object 94 is directed by one or a few mirrors of DMD 412 toward detector 414, while the background noise of reflections of light from sun 80 (e.g., reflections 82′ from snow on distant mountains 82 or reflections 84′ from glass windows of buildings 84 (or even sun reflections 92′ from other objects 92)) are reflected toward light dump 418 by other ones of the plurality of mirrors of DMD 412. In some embodiments, because there is a single laser 420 and a single detector 414, each X and Y angle must be scanned sequentially, which takes more time to scan the entire scene than system 101, but system 401 has a better S/N ratio than system 101 because for system 101 each object in the scene reflects less power toward the detectors 112, 114, . . . 116). System 401 also has a better S/N ratio than system 101 or system 301, because the intensity of laser power in system 401 is higher at each object because the entire output pulse 420′ is pointed at only one much smaller solid angle at a time, and detector 414 (because of the selections of one or more mirrors of DMD 412) receives light from only the selected small portion of the entire scene 400 that is illuminated by each of the pulses from scanned laser beam 420′. In some embodiments, a processor 490 is operatively coupled to control operation of the components described above and/or receive signals from other components of system 401, in order to determine distances to various objects in scene 400 and/or to generate a three-dimensional image, formatted data file, or map of those objects.

Thus, FIG. 4 shows system 401 with improved signal-to-noise (S/N) ratio as compared to systems 101, 201 and 301. The output-pulse operation of system 401 is similar to that of system 301 of FIG. 3; however, the operation of detection system 410 is improved using digital micromirror device (DMD) 412. In some embodiments, DMD 412 is used to reflect a selected portion of the target scene at the focal plane of lens 430 toward detector 414 and direct that selected portion of the scene (e.g., during the first period of time, the reflection 92′ of beam 420′ from object 92) to the detector 414. The rest of the target scene at the focal plane of lens 430 is directed away from the detector (e.g., toward light dump 418). The selected portion of the target scene is synchronized with the scanning laser beam 420′ such that the detector 414 only “sees” the portion of the target scanned by the laser beam at that instant of time (or period of time, since objects at different distances will have different delay times for the return pulse, so the detector is active for the period of time after the outgoing pulse in which the return pulses may be expected). As a result, all the ambient light of light 414′ reflected from areas not at the laser beam location will be directed away from the detector 414 and instead at light dump 418, thus lowering the background noise signal, and increasing the S/N ratio.

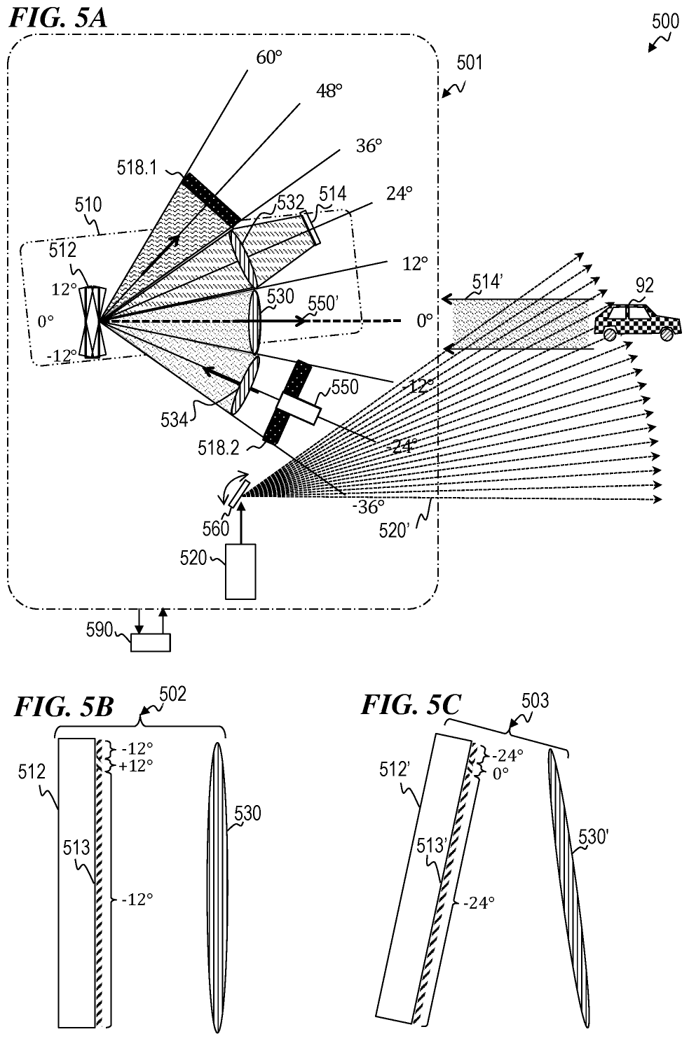

To provide added functionality and lower the cost of an overall LiDAR and smart headlight system, some embodiments of the present invention integrate these two functions in the same package using a single DMD, such as system 501 of FIG. 5A.

FIG. 5A is a side-view schematic of a scene 500 with a combined smart headlight, scanned laser-illumination, and scanned detection LiDAR system 501, according to some embodiments of the present invention. In some embodiments, combined smart headlight and LiDAR system 501 includes a pulsed laser 520 that outputs a relatively narrow-angle pulsed laser output beam 520′ that is pointed in different X-Y directions by a 2D scanning output mirror 560 to illuminate a small portion of the entire scene 500. While reflected light 514′ from the entire scene 500 is focused by lens 530 onto DMD 512 at the focal plane of lens 530, the mirror(s) of DMD 512 on only a certain computer-selected area of DMD 512 are pointed to reflect light from those mirror(s) toward detector 514, while light toward all other areas of DMD 512 is reflected by mirror(s) of DMD 512 that are controlled to reflect that light toward light dump 518.2. In some embodiments, the pulsed reflected light 514′ from that illuminated portion is focused by lens 530 (e.g., in some embodiments, lens 530 being implemented as one or more lenses, and/or a hologram or other focusing optics) onto the array of mirrors of DMD 512 located at the focal plane of lens 530, one or more of which mirrors of DMD 512 reflects light from just those XY-angle(s) (or portion(s)) of scene 500 toward which output laser beam 520′ is being directed at a given period of time, onto stationary detector 514 at the +24-degree position of detection system 510, while light from all other XY-angle(s) (or portion(s)) of scene 500 are reflected towards light dump 518.2 at the −24-degree position (in some embodiments, light dump 518.2 includes a heat sink with a black surface that is highly absorbent to wavelengths of light from scene 500). In some embodiments, an aperture is provided around the light path toward light dump 518.2 and/or the light path toward detector 514 to prevent or reduce any stray reflections from light dump 518.2 from reaching detector 514. In some embodiments, there is only a single detector 514 that is used to determine the time delay between the scanned output pulses 520′ from laser 520. In some embodiments, LiDAR system 501 is configured to successively point output laser beam 520′ at different portions (different X and Y angles) of scene 500 at sequential times by tilting 2D scanning mirror 560, and to also tilt one or more of the mirrors of DMD 512 at XY locations on DMD 512 corresponding to the X-Y angles of each given pulse of output laser beam 520′, while all other mirrors of DMD 512 reflect light from those other portions of scene 500 to light dump 518.2. In some embodiments, the X and Y tilting of mirror 560 and the tilting of the mirrors of DMD 512 to reflect toward detector 514 for the portion of scene 500 being measured (and to reflect toward light dump 518.2 for all other portions of scene 500, in order to improve the S/N ratio) allows LiDAR system 501 to point output beam 520′ toward (and to select received light 514′ from) different angles in the X and Y directions to determine Z-distances between system 501 and a plurality of objects (e.g., car 92 and the like), and thus determine the X-Y-Z locations of various objects in the scene 500. Thus, during a first period of time, pulsed output laser beam 520′ points toward the X-Y angles corresponding to object 92 (e.g., a car), and the reflection 514′ of the output laser beam 520′ from object 92 is directed by one or a few mirrors of DMD 512 toward detector 514, while the background noise (such as described above for FIG. 4) is reflected toward light dump 518.2 by other ones of the plurality of mirrors of DMD 512. In some embodiments, because there is a single laser 520 and a single detector 514, each X and Y angle used to measure distances is scanned sequentially. In some embodiments, a processor 590 is operatively coupled to control operation of the components described above and/or receive signals from other components of system 501, in order to determine distances to various objects in scene 500 and/or to generate a three-dimensional image, formatted data file, or map of those objects.

FIG. 5A, thus, shows combined smart headlight and LiDAR system 501 according to an embodiment of the present invention, in which the LiDAR output laser beam 520′ is a scanning laser beam similar to scanning laser beam 420′ as shown in FIG. 4, and includes the XY-angle-selection (to determine the location that is to be measured for its Z-distance) capabilities via the XY-tilt functions of DMD 512 without the use of multiple detectors (i.e., just a single detector 514 is used in some embodiments). Furthermore, combined smart headlight and LiDAR system 501 includes the function of a smart headlight using DMD 512 having an array of mirrors, each of which can be tilted to one of a plurality of angles, e.g., in some embodiments, to −12°, 0°, or +12°. In some embodiments, there are thousands of tiny mirrors in DMD 512, while only one mirror is shown in FIG. 5A, representing the position of one of the mirrors. When a conventional standard DMD operates, each mirror switches just to the 0° or −12° direction. Some embodiments of the present invention use the extra capability of the DMD 512 to point one or more of the mirrors in the +12° (positive 12-degree) direction as well as the −12° direction, and optionally the 0° direction. When the illumination light source 550 is placed at the −24° position as shown in FIG. 5A, the output light 550′ of illumination light source 550 will be reflected to the 0-degree position (outputting the light 550′ in a horizontal left-to-right direction in FIG. 5A) as headlight output illumination when the selected mirror(s) is (are) at the −12-degree position, which is the HEADLIGHT-ON position for the headlight function. When a respective mirror of DMD 512 is selected to be HEADLIGHT OFF with the respective mirror at the +12-degree position, the light from illumination source 550 is reflected to the 48-degree position, which is the HEADLIGHT-OFF position, with light from illumination source 550 directed away from the output direction and instead toward light dump 518 where the light is absorbed by light dump 518 (e.g., a heat sink having a highly absorbent black surface) to avoid the spilling of light from illumination source 550 into the detector 514.

Making use of the capability of the individually selectable micromirrors of DMD 512 of operating between −12-degrees and +12-degrees (whether with or without stopping at 0-degrees), the LiDAR laser beam 520′ is successively pointed to illuminate each respective target area and the reflected beam 514′ from that respective target area is collected at the focal plane of lens 530 located at the 0-degree position, which is reflected by one or more mirrors of DMD 512 that is tilted either in the −12-degree or +12-degree positions. If the respective mirror(s) of DMD 512 at the detection position is (are) tilted +12-degrees, the reflected LiDAR signal will be directed to the detector 514 at the 24-degree position, but when the respective DMD mirror is tilted at the −12-degree position, the reflected LiDAR signal will be directed to the −24-degree position where the light dump 518.2 and the headlight light source 550 are located. When the mirror at the selected position of the DMD 512, corresponding to the location of the LiDAR beam 520′ for a given output LiDAR pulse, is set to have the mirror(s) switched to the +12-degree position, the reflected signal 514′ from the selected location will be directed to the detector 514 for Z-distance determination, as described previously. When the selected mirror position of the DMD is “scanned” across the whole area of DMD 512, such as raster scanning, synchronized to the scanned LiDAR beam 520′, corresponding to the full scene 500, the full set of Z-distances, each corresponding to one of the XY-angles the targets, could be determined. This provides the function of the scanning LiDAR where the scanning function is performed by the mirror switching of the DMD 512 synchronized to the scanned pulsed LiDAR output laser beam 520′.

In some embodiments, for the smart headlight function of system 501, the headlight source 550 is positioned at the −24-degree position where the light from headlight source 550 will be reflected towards the output (0-degree) direction towards the roadway when the selected mirror(s) is/are at the −12-degree position. When the mirror is at the +12-degree position, the light from headlight source 550 will be reflected to the +48-degree direction and absorbed by the light dump 518.1. The net effect is that at the selected positions being used at a given period of time for the LiDAR detection, the headlight will be OFF at these positions and the light will be directed to the light dump 518.1 (at the +48-degree position). For all the un-selected positions where the mirrors of DMD 512 are at the −12-degree positions, the light from headlight source 550 will be output to the target as the headlight output beam. Since the tilt of the mirrors of DMD 512 at the selected area is synchronized to the scanning laser beam 520′, the scanning laser beam 520′ is pointed such that it does not illuminate these un-selected areas, and these mirrors could also be switched to +12-degree without affecting the LiDAR distance-detection function. As a result, this section of the mirrors can be used to switch ON or OFF the headlight output as desired, achieving the function of a smart headlight (i.e., illuminating just selected portions of the scene 500 in front of the vehicle).

In some embodiments, DMD devices with other mirror-switching angles (other than +12 degrees and −12 degrees) are used, with corresponding changes to the positions and/or angles at which the other components are placed. For example, if the plurality of mirrors of DMD 512 were instead capable of switching to +6-degrees and −6-degrees, the other components would be placed centered at +24 degrees instead of +48 degrees for light dump 518.1, +12 degrees instead of +24 degrees for lens 532 and light detector 514, and −12 degrees instead of −24 degrees for lens 534, light source 550 and for light dump 518.2. For embodiments using DMDs having other switched angles, corresponding changes to the positions and/or angles at which the other components are placed are made.

FIG. 5B is a side-view schematic of a DMD-lens system 502 usable with system 501, according to some embodiments of the present invention. In some embodiments, DMD-lens system 502 includes a DMD 512 and a lens 530 that focuses light coming from the scene to the right of lens 530 onto its lens focal plane at major face 513 of DMD 512. In some embodiments, DMD 512 has a plurality of switchable mirrors located at major face 513, wherein one or more subsets of the plurality of switchable mirrors are switched to an angle of +12 degrees, and another one or more subsets of the plurality of switchable mirrors are switched to an angle of −12 degrees. In other embodiments, DMD 512 has a plurality of switchable mirrors selectably switched to other angles, and the other components of system 501 DMD 512 are also adjusted in position and/or angle. In some embodiments, each one of the DMD mirrors switches between a positive (+) angle and a negative (−) angle that is selected using a drive signal, and a zero (0-degree) angle is the default mirror orientation when there is no drive signal, but the exact angle of this no-signal (0-degree) orientation tends to vary and is often not repeatable or reliable.

FIG. 5C is a side-view schematic of an alternative DMD-lens system 503 usable with system 501, according to some embodiments of the present invention. In some embodiments, DMD-lens system 503 includes a DMD 512′ and a lens 530′ that focuses light coming from the scene to the right of lens 530′ onto its lens focal plane at major face 513′ of DMD 512′. In some embodiments, DMD 512′ has a plurality of switchable mirrors located at major face 513′, wherein one or more subsets of the plurality of switchable mirrors are switched to an angle of +0 degrees relative to major face 513′, and another one or more subsets of the plurality of switchable mirrors are switched to an angle of −24 degrees relative to major face 513′. In some embodiments, DMD 512′ is tilted such that major face 513′ is at an angle of +12 degrees, such that the mirrors at +0 degrees relative to major face 513′ are at +12 degrees, and the mirrors at −24 degrees relative to major face 513′ are at −12 degrees. In some embodiments, lens 530′ is tilted such that the focal plane of lens 530′ is focused at the tilted major face 513′. In other embodiments, DMD 512′ has a plurality of switchable mirrors selectably switched to other angles, and the other components of system 501 using DMD 512′ are also adjusted in position and/or angle. Some embodiments use a DMD (e.g., for DMD 512′ or DMD 512) with larger switching angles. For example, +/−14 degrees, and up to +/−17 degrees, are available but are generally less available for automotive applications.

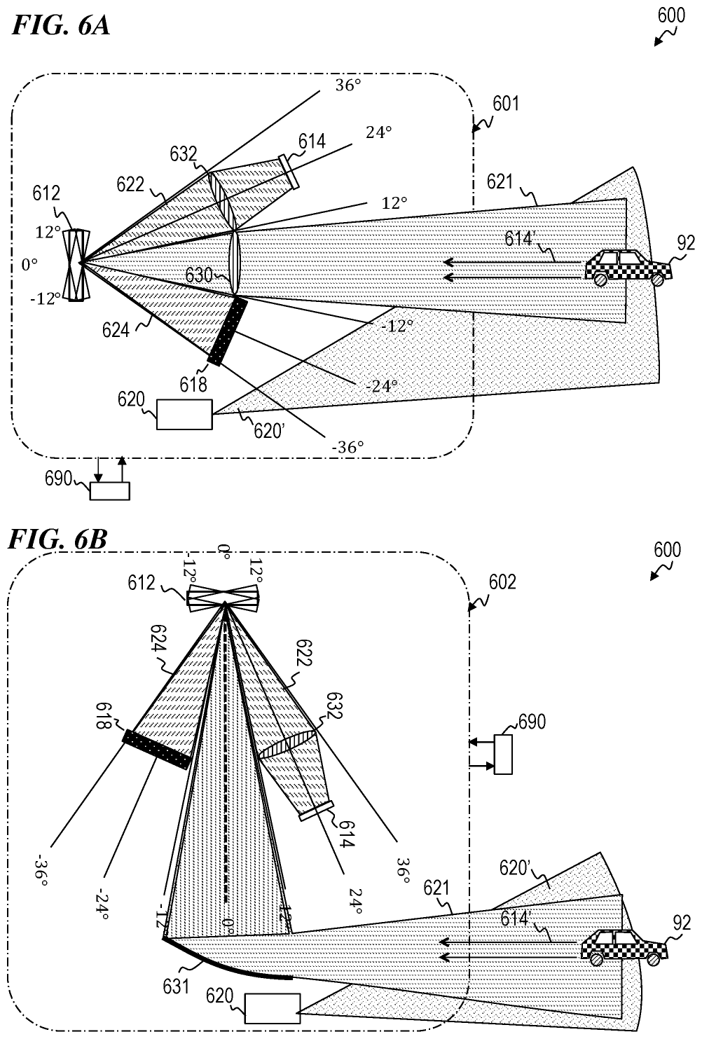

FIG. 6A is a side-view schematic of a scene 600 with full-field laser-illumination and scanned detection LiDAR system 601, according to some embodiments of the present invention. In some embodiments, LiDAR system 601 includes a pulsed laser 620 that outputs a high-power relatively wide-angle pulsed laser output beam 620′ configured to simultaneously illuminate all X-Y angles of the entire scene 600. While light 621 from the entire scene 600 is focused by lens 630 onto DMD 612 at the focal plane of lens 630, the mirror(s) of DMD 612 on only a certain computer-selected area of DMD 612 are pointed to reflect light from those mirror(s) toward detector 614, while light toward all other areas of DMD 612 is reflected by mirror(s) of DMD 612 that are controlled to reflect that light toward light dump 618. In some embodiments, the pulsed reflected light 621 (as well as ambient light) from the entire scene 600 is focused by lens 630 (e.g., in some embodiments, lens 630 being implemented as one or more lenses, and/or a hologram or other focusing optics) onto the array of mirrors of DMD 612 located at the focal plane of lens 630, one or more of which mirrors of DMD 612 reflects light 614′ from just those XY-angle(s) (or portion(s)) of scene 600), of interest at a given period of time, as light 622 onto stationary detector 614 at the +24-degree position of detection system 610, while light 624 from all other XY-angle(s) (or portion(s)) of scene 600) is reflected towards light dump 618 at the −24-degree position (in some embodiments, light dump 618 includes a heat sink with a black surface that is highly absorbent to wavelengths of light from scene 600). In some embodiments, an aperture is provided around the path of light 624 toward light dump 618 and/or the path of light 622 toward detector 614 to prevent or reduce any stray reflections from light dump 618 from reaching detector 614. In some embodiments, there is only a single detector 614 that is used to determine the time delay between the full-field output pulses 620′ from laser 620. In some embodiments, LiDAR system 601 is configured to successively point light 622 from different X and Y angles of scene 600 at sequential times by tilting a selected one or more of the mirrors of DMD 612 at XY locations on DMD 612 corresponding to the X-Y angles of each location whose distance is being measured to reflect towards detector 614, while all other mirrors of DMD 612 reflect light from other portions of scene 600 to light dump 618. In some embodiments, the tilting of the mirrors of DMD 612 to reflect toward either detector 614 for the portion of scene 600 being measured (and to reflect toward light dump 618 for all other portions of scene 600, in order to improve the S/N ratio) allows LiDAR system 601 to select received light 614′ from different angles in the X and Y directions to determine Z-distances between system 601 and a plurality of objects in scene 600 (e.g., car 92 and the like), and thus determine the X-Y-Z locations of various objects in the scene 600. Thus, during a first period of time, the reflection 614′ of the output laser beam from object 92 is directed by one or a few mirrors of DMD 612 toward detector 614, while the background noise (such as described above for FIG. 4) is reflected toward light dump 618 by other ones of the plurality of mirrors of DMD 612. In some embodiments, because there is a single laser 620 and a single detector 614, each X and Y angle used to measure distances is selected sequentially. In some embodiments, a processor 690 is operatively coupled to control operation of the components described above and/or receive signals from other components of system 601, in order to determine distances to various objects in scene 600 and/or to generate a three-dimensional image, formatted data file, or map of those objects.

FIG. 6B is a side-view schematic of a scene 600 with full-field laser-illumination and scanned detection LiDAR system 602, according to some embodiments of the present invention. In some embodiments, system 602 is equivalent to system 601 in form and function, with the exception that the optics of lens 630 of FIG. 6A is replaced by reflective optics 631. In some embodiments, reflective optics 631 is coated with a plurality of dielectric layers so as to be highly reflective at the wavelength of the LiDAR beam 620′, and thus can be more efficient at gathering LiDAR reflections 614′ than a lens 630.

Referring again to FIG. 6A, system 601 represents another embodiment of the present invention, where the targets of scene 600 are all illuminated by a high-power pulsed LiDAR signal 620′ covering the full area of the target. A selected portion (i.e., one or more) of the mirrors of DMD 612 will be switched to the +12-degree position such that the reflected LiDAR signal 614′ is detected by detector 614 and the Z-distance at the selected XY-angle is calculated. Again, in some embodiments, the mirrors of DMD 612 are switched in turn for each successive LiDAR pulse of full-field beam 620′, providing the function of the raster scan that selects successive portions of the received signal repeatedly, covering the full area of the target scene 600 without the need for a scanning mirror for laser 620, nor the need to synchronize the scanning mirror to the switched mirror(s) of DMD 612. In some embodiments, depending on the strength of the signal 620′ at the certain selected portion of the target, the number of the DMD mirrors selected is chosen such that the signal 622 is detected with sufficient signal-to-noise (S/N) ratio for accurate positioning. Using such switched mirrors of DMD 612 for detection, in some embodiments, the number of switched mirrors is determined based on the strength of the signal at a particular object in the target area. When the signal is weak, more mirrors are switched, lowering the resolution of the detected target region, which could be a more-distant object, for example. When the signal is strong, fewer mirrors are switched, increasing the resolution of the detected target region. This could be a closer object in which high resolution will be more beneficial.

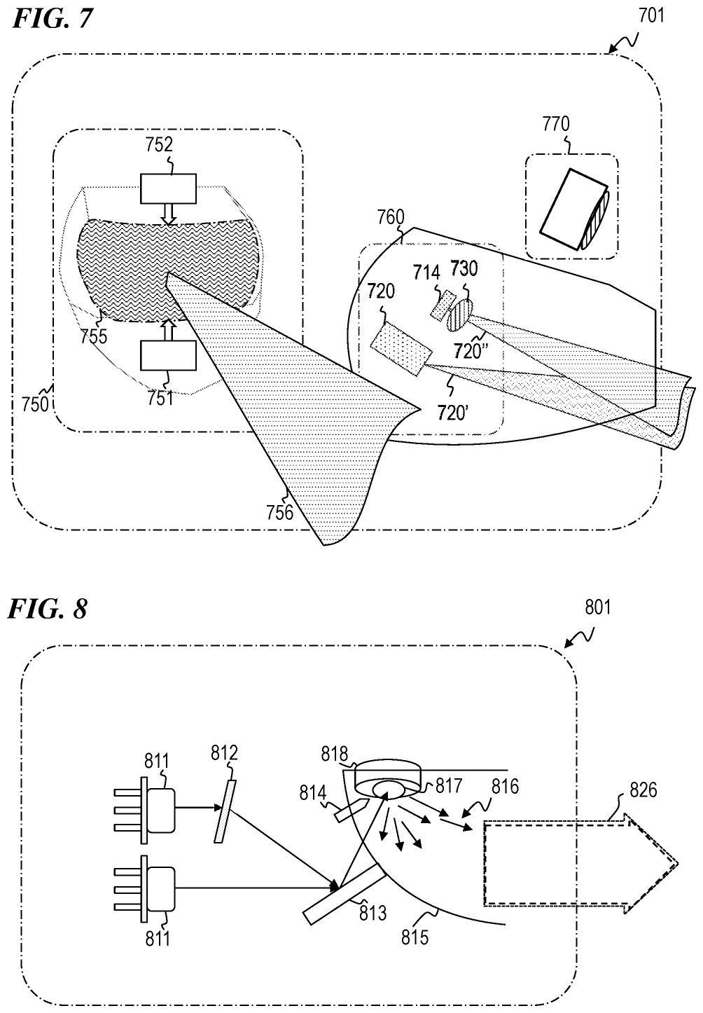

FIG. 7 is a perspective-view schematic of a combined smart headlight and LiDAR system 701, according to some embodiments of the present invention. In some embodiments, combined smart headlight and LiDAR system 701 includes a LiDAR sensor 760 and a laser-headlight module (LHM) 750. In some embodiments, LHM 750 includes a low-beam light source 752 and a high-beam light source 751, either or both of which is configured to changeably configure the shape, size, and/or direction of the headlight output illumination. In some embodiments, the 3D information from the LiDAR sensor 760 and image data from a CCD (charge-coupled device) imager 770 or other digital imager are combined to obtain scene data that is used to configure the shape, size, and/or direction of the headlight output illumination from LHM 750.

In some embodiments, the combined smart headlight with scanned laser-pumped illumination and LiDAR system 701 is usable, for example, for autonomous driving. In some embodiments, LiDAR sensor 760 includes an assembly from LeddarTech, Inc. (such as a Leddar Vu8 module with Medium FOV (field of view)) with the wavelength of 905 nm. In some embodiments, LHM 750 includes a highly reliable glass-phosphor substrate that exhibits excellent thermal stability, two blue-laser diodes, and two blue LEDs (light-emitting diodes). In some embodiments, the glass yellow-phosphor wavelength-converter substrate layer is mounted to a copper thermal-dissipation substrate, and a parabolic reflector is used to reflect blue light and yellow-phosphor light to form one or more selectable white-light headlight beams (e.g., either a low-beam pattern beam, a high-beam pattern beam, or both, or a variable-spatial-extent beam having selectable variable brightnesses at different locations in the beam). In some embodiments, LHM 750 exhibits total output optical power of 9.5 W, luminous flux of 4000 lm, relative color temperature of 4300 K, and efficiency of 421 lm/W. In some embodiments, the high-beam patterns of LHM 750 were measured to be 180,000 luminous intensity (cd) at 0° (center), 84,000 cd at ±2.5°, and 29,600 cd at ±5°, which well satisfied the ECE R112 (Economic Commission Europe regulation R112) class B regulation. The low-beam patterns also well satisfied the ECE R112 regulation. The beam range of headlight from LHM 750 was measured to be more than 300 meters (300 m). Employing a smart algorithm, some embodiments include automatically selected on/off portions of the smart headlight beams through integration of distance-measurement data from the LiDAR unit 760 and data from CCD (charge-coupled device) imager 770. In some embodiments, the recognition rate of objects by the LiDAR-CCD system was evaluated to be more than 86%. The novel LiDAR-embedded smart LHM of system 701 with its unique high-reliability glass phosphor-converter layer is a promising candidate for automotive use in the next generation of high-performance autonomous-driving applications.

In automotive applications of LiDAR technology, most existing conventional LiDAR sensors are installed on the top of the vehicle. Conventional LiDAR sensors continuously rotate and generate thousands of output laser pulses per second. These high-speed pulsed laser beams from LiDAR are continuously emitted in the 360-degree surroundings of the vehicle and are reflected by objects in the environment. Employing smart algorithms, the data received from the LiDAR scanner is converted into real-time 3D information, such as 3D graphics, which are often displayed as 3D maps of the surrounding objects, and/or machine-vision data, used for control of the vehicle motion and/or warning systems for the human driver of the vehicle.

However, placing the LiDAR sensor on the top of the vehicle may cause many issues, such as close-range dead angle (areas that are near to the vehicle but not detectable from the top of the vehicle), collecting dust, water corrosion, and difficulty in connecting the electrical system in the LiDAR sensors to the other information processors in the vehicle. In addition, this conventional top-of-vehicle design of LiDAR does not follow the aesthetic conceptions of customer desires or requirements. In contrast to the LiDAR sensors mounted on the top of the vehicle, the present invention integrates the LiDAR into the vehicle's headlight systems to solve the aforementioned issues. Therefore, the problems of close-range dead angle and air/water corrosion of the LiDAR are prevented by the cover of the headlight. The electrical system and heat-dissipation are more easily handled by locating the LiDAR in with the vehicle headlight system.

In some embodiments, the present invention provides a new combination of a smart laser-headlight module (LHM) 750 with an embedded LiDAR sensor 760 by integrating the optical system of the LiDAR into the headlight assembly as a unit in which control of the laser-pumped headlight is achieved by feedback control orders from a smart system that utilizes 3D data from the LiDAR sensor(s) 760 and/or CCD 770. In some embodiments, the LiDAR sensor 760 used is fabricated by LeddarTech, Inc. [5].

In some embodiments (see FIG. 8), LHM 750 includes two blue-laser diodes 811, two blue LEDs (not shown), a glass-based yellow-phosphor wavelength-converter layer having a copper thermal-dissipation substrate as a heat sink, and a parabolic reflector to reflect and combine blue light and yellow phosphor light into white light. In some embodiments, the novel glass-based yellow phosphor-converter layers used are fabricated using a low-temperature process of 750° C., which exhibits excellent thermal stability [6-8]. The measured high-beam and low-beam patterns of the LHMs well satisfied the ECE R112 (Economic Commission Europe R112) class B regulation. Some embodiments employ a smart algorithm to provide an on/off smart headlight through integration of the LiDAR detection of object distance with a CCD (charge-coupled device) image. In some embodiments, the recognition rate of vehicle and objects was evaluated to be more than 86%. Therefore, the present invention that includes a novel LiDAR-embedded smart LHM having a highly reliable glass-phosphor wavelength-converter layer is promising for automotive use in the next generation of high-performance autonomous driving applications.

Fabrication of a Glass-Based Phosphor Wavelength-Converter Layer

One primary benefit to a human driver of a vehicle that uses laser-diode (LD) headlights is that the beam range can be up to 600 meters [9]. This offers the driver improved visibility, contributing significantly to road-traffic safety. Most conventional white-LD engines are integrated using a blue LD and a phosphor wavelength-converter layer. The headlight's laser-based phosphor wavelength-conversion layer(s) have conventionally been fabricated using ceramic [10], single-crystal [11], or glass materials [12]. However, the fabrication temperatures of the ceramic-based and single-crystal-based phosphor were over 1200° C. and 1500° C., respectively. These high-temperature fabrications can be difficult for commercially viable production. In previous reports [6-8], glass-based-phosphor wavelength-converter layers made by process temperatures as low as 750° C. had shown better thermal stability than the silicone-based color-conversion (wavelength-converter) layers. The glass-based phosphor with its better thermal stability is used in some embodiments of the LD light engines of the present invention.

In some embodiments, the fabrication procedures of glass-based yellow phosphor-converter layer (Ce³⁺:YAG) include the preparation of sodium mother glass by melting a mixture of raw materials at 1300° C. and dispersing Ce³⁺:YAG powders into the mixture by gas-pressure and sintering under different temperatures [6-8]. The composition of the sodium mother glass was 60 mol % SiO₂, 25 mol % Na₂CO₃, 9 mol % Al₂O₃, and 6 mol % CaO. The resultant cullet glass of the SiO₂—Na₂CO₃—Al₂O₃—CaO was dried and milled into powders. The Ce³⁺:YAG crystals were uniformly mixed with the mother glass and sintered at 750° C. for one hour and then annealed at 350° C. for three hours, followed by cooling to room temperature. The concentration of Ce³⁺:YAG with 40 wt % exhibited the higher luminous efficiency and provided better purity for yellow color phosphor wavelength-converter layers [6-8]. Then, the glass-phosphor bulk was cut into the disks of the phosphor wavelength-converter layer with a diameter of 100 mm and thickness of 0.2 mm.

In comparison with commercial silicone-based phosphor-converter layers, the glass-based phosphor wavelength-converter layers exhibited better thermal stability in lumen degradation and lower chromaticity shift. These benefits were due to the glass-based phosphor-converter layer(s) exhibiting a higher transition temperature (550° C.), a smaller thermal expansion coefficient (9 ppm/° C.), a higher thermal conductivity (1.38 W/m° C.), and higher Young's modulus (70 GPa) than the silicone-based phosphor-converter layers.

The design and fabrication of high-beam laser headlight module (LHM) 751 and low-beam LED headlight module (LEDHM) 752 for some embodiments are set forth below.

FIG. 7 shows integrated smart laser headlight and LiDAR system 701, which includes of a high-beam laser headlight module (LHM) 751, a low-beam LED headlight module (LEDHM) 752, and a LiDAR module 760. Some embodiments also include a digital imager 770 that obtains images from visible light (e.g., wherein each pixel of each obtained image has data for red, green and blue (RGB data). In some embodiments, all of the components of integrated smart laser headlight and LiDAR system 701 are packaged together and mounted to a vehicle in the location usually occupied by the vehicle headlight.

FIG. 8 is a side-view schematic of a high-beam LHM system 801 usable as a smart headlight with scanned laser-pumped illumination, according to some embodiments of the present invention. In some embodiments, system 801 includes a plurality of laser diodes 811, each outputting pump wavelengths (e.g., in some embodiments, blue light having about 445-nm wavelength; in other embodiments, other pump wavelengths in the range of 420 nm to 480 nm, or in the range of 430 nm to 460 nm, or in the range of 440 nm to 450 nm are used) that are used to excite the phosphors in glass phosphor plate 817, which is mounted to a heatsink 818 (e.g., in some embodiments, a copper thermal-dissipation plate). In some embodiments, a parabolic reflector 815 is used to shape light 816 from phosphor wavelength-conversion plate 817 (wherein light 816 includes blue light from the pump diodes 811 and yellow light resulting from wavelength conversion by the phosphor plate 817) as output beam 826 (e.g., a high-beam headlight illumination shape, which includes a portion of unconverted short-wavelength light indicated by dotted line and wavelength-converted light indicated by dashed line), which has a white color. In some embodiments, the white color of output beam 826 is selected to have a color temperature in the range of about 2700K to about 6000K by adjusting the amount of yellow phosphor (for example, by adjusting concentration in the glass plate or the thickness of the glass plate), in order to adjust the proportion of wavelength-converted yellow light to the amount of unconverted blue light from the laser diodes 811.

In some embodiments, the high-beam LHM system 801 includes two blue laser diodes 811, two blue LEDs, a glass phosphor-converter layer 817 with a copper thermal dissipation substrate 818, and one parabolic reflector 815 to reflect blue light and yellow phosphor light into white light 816, as shown in FIG. 8. In some embodiments, blue lasers from Nichia with wavelength of 445-nm are used. In some embodiments, LHM system 801 exhibited total output optical power of 9.5 W, luminous flux of 4000 lm, relative color temperature of 4300 K, and efficiency of 420 lm/W. The glass phosphor-converter layer 817 was fabricated by a low-temperature process of 750° C. and mounted on a copper thermal-dissipation substrate 818. An infrared thermal-imaging camera showed that the temperature profile of the LHM 810 with copper substrate 818 had an average temperature of 48° C. after a long operation time of more than one hour. In some embodiments, copper thermal-dissipation substrate 818 solves the thermal effect of the LHM. In some embodiments, the combination of refractor 812 (e.g., a prism, diffraction grating, or the like) and flat reflector 813 is used to integrate beams from the two blue lasers 811 and reflect into the glass phosphor-converter layer 817. In some embodiments, parabolic-reflector 815 improves the white light pattern of the LHM to satisfy the ECE R112.

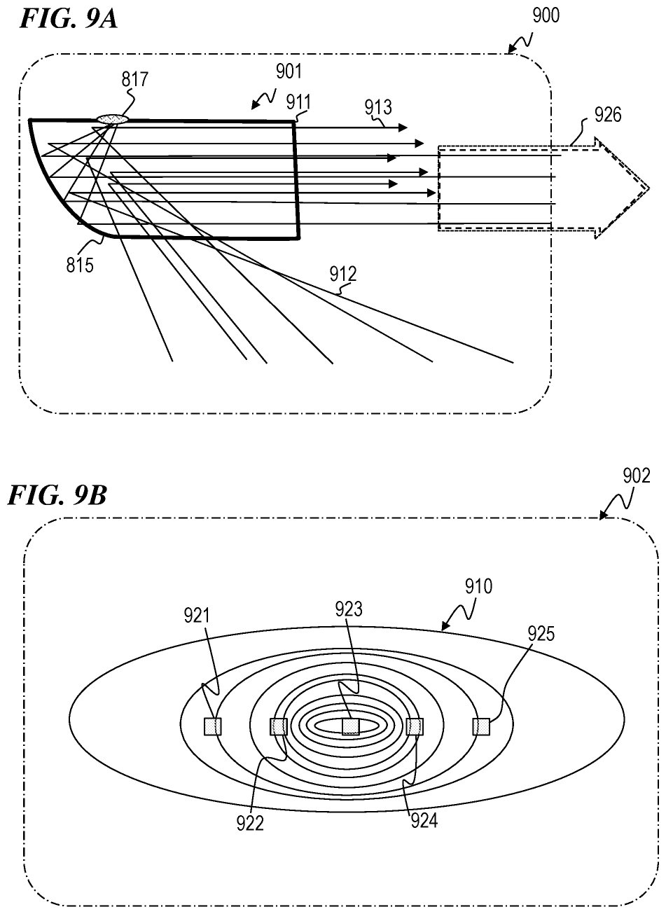

FIG. 9A is a schematic diagram of a ray-tracing simulation 900 of a smart headlight system 901, according to some embodiments of the present invention. In some embodiments, the parabolic reflector 911 and the placement location of the phosphor plate 817 are configured with ray-tracing software to provide a suitable high-beam illumination profile, with the individual rays 912 through 913 traced by the simulation software. Output beam 926 (e.g., a high-beam headlight illumination shape, which includes a portion of unconverted short-wavelength light indicated by dotted lines and wavelength-converted light indicated by dashed lines).

FIG. 9B is a schematic diagram of illumination intensity 902 from a smart headlight system 901, according to some embodiments of the present invention. In some embodiments, the profile of illumination intensity 902 includes iso-intensity lines 910 of concentric increasing intensity toward the center of the beam. In some embodiments, five measurement points 921 through 925 are calculated from the simulation and then measured from the implemented reflector design as built. In some embodiments, measurement point 921 corresponds to location 2.25L at −5 degrees (to the left), measurement point 922 corresponds to location 1.125L at −2.5 degrees (to the left), measurement point 923 corresponds to location Iₘₐₓ at 0° (center), measurement point 924 corresponds to location 1.125R at +2.5 degrees (to the right), and measurement point 925 corresponds to location 2.25R at +5 degrees (to the right).

TABLE 2
Measurement, safety accreditation of ECE R112
class B, and simulation for high-beam LHM 751

| Test point | Class B (cd) | Simulation (cd) | Measurement (cd) |
|---|---|---|---|
| Imax (0°) | >40,500 | 189,777 | 180,000 |
| H-1.125L/R (±2.5°) | >20,300 | 88,740 | 84,000 |
| H-2.25L/R (±5.0°) | >5,100 | 35,726 | 29,600 |

A simulation tool of the SPEOS software was used to design the high-beam LHM 801 used for some embodiments of high-beam laser headlight module (LHM) 751 in system 701. FIG. 9A shows the ray-tracing diagram and FIG. 9B shows the iso-intensity lines of the light distribution pattern of high-beam LHM 801. In this study, eye safety is an important issue since high power lasers are used. In some embodiments, a white-light sensor 814, shown in FIG. 8, is installed to monitor whether the lasers and glass-phosphor layer are functioning properly. If there is function failure caused by a car accident, the monitor 814 will sense these problems and send a signal to disable the blue lasers, preventing the risk of laser leakage. The high-beam patterns of the LHMs 751 were measured and simulated, as shown in Table 2. The high-beam patterns of the LHMs 751 were measured to be 180,000 luminous intensity (cd) at 0° (center), 84,000 cd at ±2.5°, and 29,600 cd at ±5°, which well satisfied the safety accreditation of the high-beam of the ECE R112 class B regulation. The beam range of high-beam headlight was measured to be more than 300-m. The difference between the measurement and simulation of the patterns might be caused by fabrication and assembly error.

TABLE 3
Measurement, safety accreditation of ECE R112 class
B, and simulation for low-beam LED module 1002

| Test point | Class B (cd) | Simulation (cd) | Measurement (cd) |
|---|---|---|---|
| B50L | ≤350 | 105 | 330 |
| 75R | ≥10,100 | 12,800 | 12,880 |
| 75L | ≤10,600 | 9,950 | 7,840 |
| 50L | ≤132,00 | 11,160 | 7,280 |
| 50R | ≥10,100 | 10,890 | 28,000 |
| 50V | ≥5,100 | 10,710 | 11,088 |
| 25L | ≥1,700 | 4,337 | 17,360 |
| 25R | ≥1,700 | 4,383 | 15,120 |
| op | | | |
| Point 1 + 2 + 3 | ≥190 | 950 | 952 |
| Point 4 + 5 + 6 | ≥375 | 1,350 | 1327 |
| Point 7 | ≥65 | 423 | 470 |
| Point 8 | ≥125 | 500 | 554 |
| Zone III | ≤625 | 536 | 448 |
| Zone IV | ≥2,500 | 8,528 | 3158 |
| Zone I | ≤56,000 | 9,682 | 44,800 |

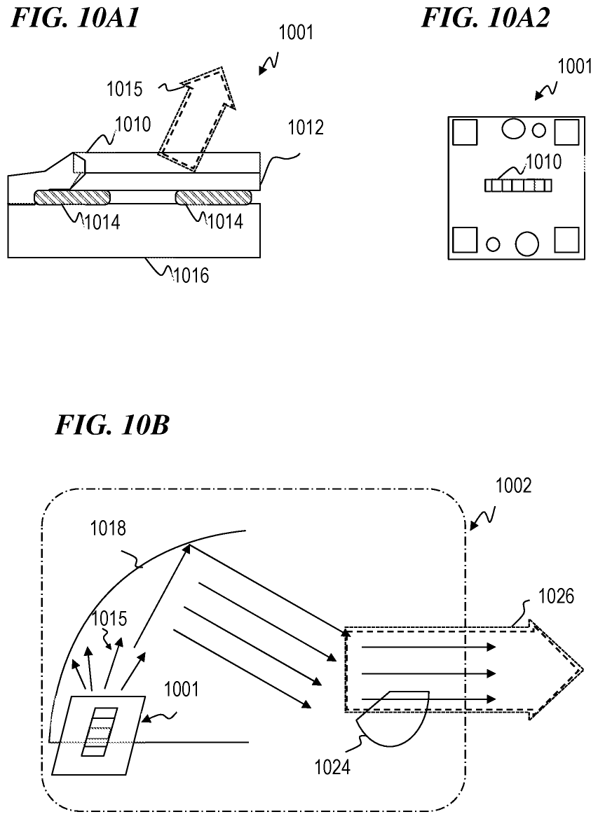

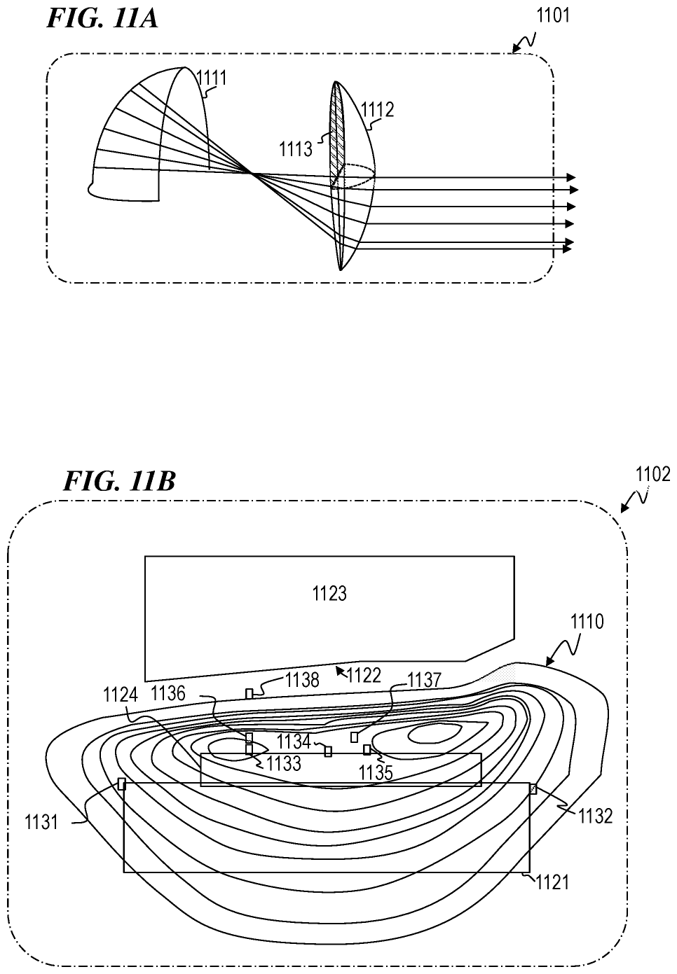

FIG. 10A1 is a cross-section side-view schematic diagram of an LED-pumped glass-phosphor wavelength-converting low-beam LED headlight module (LEDHM) 1001 usable for a smart headlight system, according to some embodiments of the present invention. In some embodiments, one or more LEDs 1014 that are mounted to a heatsink substrate 1016 and emit (in an upward direction in FIG. 10A1) pump light (e.g., in some embodiments, blue light having about 445-nm wavelength; in other embodiments, other pump wavelengths in the range of 420 nm to 480 nm, or in the range of 430 nm to 460 nm, or in the range of 440 nm to 450 nm are used) that is used to excite the phosphors in glass phosphor plate 1010, and an epoxy 1012 is used to hold a glass phosphor wavelength-conversion plate 1010 over the LED(s) 1014. A combination of unconverted blue light and wavelength-converted yellow light is emitted upward as the output light 1015, which has a white color. In some embodiments, the white color of output beam 1026 (see FIG. 10B, output beam 1026 (e.g., a low-beam headlight illumination shape, which includes a portion of unconverted short-wavelength light indicated by dotted line and wavelength-converted light indicated by dashed line)) is selected to have a color temperature in the range of about 2700K to about 6000K by adjusting the amount of yellow phosphor (by adjusting concentration in the glass plate or the thickness of the glass plate), in order to adjust the proportion of wavelength-converted yellow light to the amount of unconverted blue light from the laser diodes 811.

FIG. 10A2 is a top-view schematic diagram of LEDHM 1001 having a glass-phosphor wavelength-conversion plate 1010 over the LED(s) (in some embodiments, five LEDs are used), usable for a smart headlight system, according to some embodiments of the present invention.

FIG. 10B is a cross-section side-view schematic diagram of a low-beam smart headlight system 1002, according to some embodiments of the present invention. In some embodiments, low-beam smart headlight system 1002 includes LEDHM 1001 described above mounted in a parabolic reflector 1018. The white light 1015 emitted from LEDHM 1001 is shaped by parabolic reflector 1018 and some of that light is blocked by mask 1024 and the remainder is output as low-beam headlight illumination output beam 1026. In some embodiments, system 1002 includes five blue LEDs 1014, glass phosphor-converter layer 1010 held by epoxy 1012 to LEDs 1014 on copper substrate, an ellipse-reflector 1018, a mask 1024, and an aspherical lens. In some embodiments, OSRAM blue LEDs with wavelength of 445-nm are used, and the resulting system 1002 exhibited luminous flux of 3100 lm, relative color temperature of 6000 K, and efficiency of 310 lm/W.

FIG. 11A is a schematic diagram of a ray-tracing simulation 1101 of a smart headlight system 1002, according to some embodiments of the present invention. In some embodiments, an elliptical reflector 1111 is used with an aspherical lens 1112 and a mask 1113 to form a low beam with a cut-off line (above which little or no illumination is output) to avoid the low beam headlight interfering with the vision of oncoming traffic. In some embodiments, the elliptical reflector 1111, the aspherical lens 1112 and mask 1113, and the placement location of the LEDHM 1001 (see FIG. 10B) are configured with ray-tracing software to provide a suitable low-beam illumination profile, with the individual rays traced by the simulation software.

FIG. 11B is a schematic diagram of illumination intensity 1102 from a smart headlight system 1002, according to some embodiments of the present invention. In some embodiments, the profile of illumination intensity 1102 includes iso-intensity lines 1110 of concentric increasing intensity toward the center of the beam. In some embodiments, a plurality of measurement points 1131 through 1138 are calculated from the simulation and then measured from the implemented reflector design as built. In some embodiments, measurement point 1131 corresponds to 25L (to the left), measurement point 1132 corresponds to 25R (to the right), measurement point 1133 corresponds to 50L, measurement point 1134 corresponds to 50V, measurement point 1135 corresponds to 50R, measurement point 1136 corresponds to 75L, measurement point 1137 corresponds to 75R, and measurement point 1138 corresponds to B50L. Zone I is the rectangle 1121, Zone IV is the rectangle 1124, and Zone III is the truncated rectangle 1123 having cut-off line 1122 at its bottom edge.

FIG. 11A shows the simulation of ray tracing diagram, and FIG. 11B shows an iso-intensity plot of the 2D intensity-distribution pattern of LED low-beam module, which was based on the design of each test point and asymmetric cut-off line with a mask.

In the low-beam headlight of the left-hand-drive-type vehicle, an asymmetric cut-off line was necessary to illuminate far road and significantly prevent amounts of light from being cast into the eyes of drivers of oncoming cars, as indicated in FIG. 11B. Cut-off line 1122 was established on the one hand as a natural part separating bright and dark area in the conventional low beam. It was assigned as an essential function of the visual aiming of headlights. The cut-off line definition was a horizontal straight line on the side opposite to the direction of traffic for which the headlight was intended. In some embodiments, the shape of the cut-off line 1122 was horizontal on the left side and slant line 15° to the right or angular line 45° degree and then horizontal, as shown in FIG. 11B.

The low-beam patterns of the LEDHMs 1001 were measured and simulated, as shown in Table 3 (above), and all of the test points followed the safety accreditation of the low-beam of the ECE R112. The low-beam patterns of the LEDHM were measured to be 44,800 luminous intensity (cd) at Zone I, 448 cd at Zone III, and 3,158 cd at Zone IV, which well satisfied the safety accreditation of the low-beam of the ECE R112 class B regulation. The difference between the measurement and simulation of the patterns might be caused by fabrication and assembly error.

Package and Measurement of LiDAR Sensor

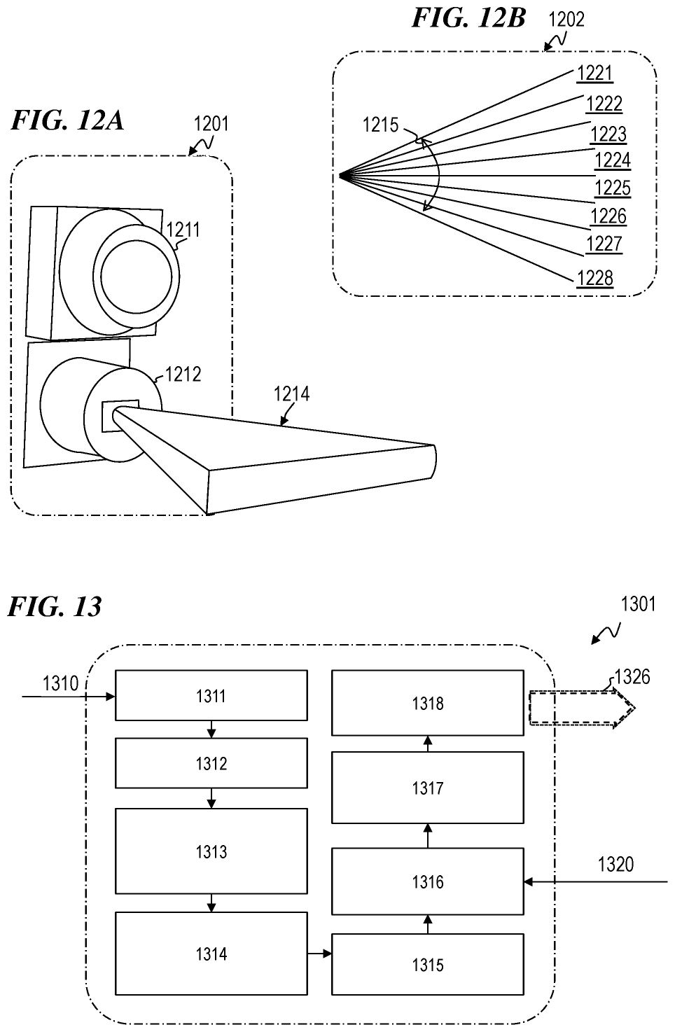

FIG. 12A is a perspective block diagram of a LiDAR system 1201, according to some embodiments of the present invention. In some embodiments, LiDAR system 1201 (e.g., in some embodiments, a conventional LiDAR module (for example, a Leddar Vu8 module with Medium FOV (field of view))) includes an imager portion 1211 and a wide-angle LiDAR laser-beam emitter portion 1212 that emits a beam 1214, wherein reflections from the scene are gathered by the lens of imager portion 1211. In some embodiments, beam 1214 has a horizontal spread of 48 degrees, and the imager includes eight detectors, each measuring distance from one-eighth (i.e., six degrees) of the emitted beam 1214.

FIG. 12B is a schematic diagram of operation of a software system 1202, according to some embodiments of the present invention. In some embodiments, the spread angle 1215 is 48 degrees, and each of the eight detector segments obtains a distance measurement from one of the six-degree arcs 1221, 1222, 1223, 1224, 1225, 1226, 1227, and 1228.

In some embodiments, a conventional LiDAR module (for example, a Leddar Vu8 module with Medium FOV (field of view)) [5] is embedded with a smart laser-headlight module (LHM) and the LiDAR detection software is shown in FIGS. 12A and 12B. With the feedback of the LiDAR, a smart LHM 701 (see FIG. 7) can control the headlight field, avoid high-reflection areas at night, and monitor all directions to ensure safe driving. The Leddar Vu8 with Medium FOV, as shown in FIG. 12A, was used to track multiple objects simultaneously in the sensor field of view, including lateral discrimination, without any moving parts, which was embedded in the laser headlight. In some embodiments, the light source, wide-angle LiDAR laser-beam emitter portion 1212, of LiDAR (shown in the lower part of FIG. 12A) includes a 905-nm laser emitter combined with diffractive optics that provided a wide illumination beam with viewing angle of 48° (horizontal)×3° (vertical). In some embodiments, the receiver assembly (upper part of FIG. 12A) includes eight independent detection elements with simultaneous multi-object measurement capabilities supported by software of signal-processing algorithms, that provides eight simultaneous distance measurement for the eight angles labeled 1221-1228 as shown in FIG. 12B. In some embodiments, the LiDAR detection range has eight six-degree channels within the sensor's capability of 48 degrees, which respectively output eight detected-vehicle distances, and eight channels correspond to the high-beam area. The detected multi-objects were shown in the dotted lines 1230 at 20 meters. Using optical path and wavelength differences, the optical signal of LiDAR did not interfere with CCD images obtained using illumination from the laser headlight systems 751 and 752, and therefore, high-quality optical data could be obtained. The image and distance data obtained using smart chips and software technology in LiDAR detection and CCD image were integrated to determine the distances and different objects from large amounts of data, which provide fast feedback to ensure safe driving.

Recognition Method 1301 of Smart LHM 701.

FIG. 13 is a block diagram of a headlight-control method and system 1301, according to some embodiments of the present invention. In some embodiments, method 1301 includes RGB-to-HSV conversion 1311 of the RGB image data 1310 of the scene obtained from digital imager 770 to corresponding hue-saturation-value (HSV) data, HSV filtering 1313, type-converting function 1313 to remove noise from the image data, using image markers to calculate block position, size, and shape 1314, limiting the block size 1315, drawing 1316 a frame and center cross using LiDAR data 1320, determining 1317 which headlight area is to be illuminated, and controlling 1318 the shape, size, direction, intensity, superimposed symbols, etc., of the headlight beams 1326 of the vehicle. In some embodiments, the combined image data and LiDAR distance data are used to detect pedestrian(s) in the scene and the headlight beam is controlled by modulating the scanned pump laser beam(s) such that a symbol (such as an enhanced-intensity cross or other suitable symbol) is formed in the headlight beam to point out the detected pedestrian(s) to the driver of the vehicle.

In some embodiments, a simple Hue-Saturation-Value (HSV) method is used to determine detection-and-tracking robustness of the vehicle. In some embodiments, the HSV method describes colors in terms of their shade (the hue and saturation parameters) and brightness (the value parameter). Employing the HSV method, the recognition rate of vehicle and the brightness/shade area controlled of headlight are determined. This offers the driver improved visibility, contributing significantly to road traffic safety. FIG. 13 is a block diagram of the HSV method used in some embodiments. The HSV method includes converting 1311 pixels from RGB space to HSV space, filtering 1312 the HSV parameters, morphological image processing 1313, image labeling 1314 function, block size limiting 1315, determining 1316 the region-of-interest (ROI) area with frame and center cross lines, LiDAR data input 1320, determining 1317 the illumination area for which the headlights are to be illuminated, and controlling 1318 the headlights. The colors of the areas to be illuminated by headlights can be roughly divided into white and yellow. In some embodiments, two upper and lower thresholds of HSV are set by using two HSV filters, to allow only the headlights and taillights to be indicated in the obtained image data.

For example, in some embodiments, a bitmap image is obtained from digital imager 770 (such as shown in FIG. 7), where each pixel of the bitmap image initially has associated 8-bit values for the R, G and B color components. In some embodiments, the RGB components are transformed to create hue-saturation-value (HSV) data. In some embodiments, the RGB data are converted to separate intensity, hue and saturation images by first transforming the RGB values of each pixel to the three components of the YCbCr color model. In some embodiments, the equations for these transformations are as follows:

$$Y = 0.299 R + 0.587 G + 0.1 \; 14 B$$

$$Cr = 0.7 \; 01 R - 0.587 G + 0.1 \; 14 B$$

$$Cb = - 0.299 R - 0.587 G + 0.886 B$$

where Y is the luminance or intensity of the pixel and Cr and Cb are color components of the YCbCr color model. In some embodiments, hue and saturation are then derived from Cr and Cb by the following formulas:

$$Saturation = square root ( Cr 2 + Cb 2 )$$

$$Hue = arctan ( C r / C b )$$

In other embodiments, other color representations are used for the received image data.

In some embodiments, the present invention is primarily interested in those portions of the CCD visual (image) area that are illuminated by the headlights of the vehicle having the combined smart headlight and LiDAR system, in which data from the CCD images are integrated with LiDAR distance-measurement data into the image-recognition board [13]. In some embodiments, a six-column by two-row (6×2) region of interest (ROI) is defined in the headlight-illumination area according to the range of driver visibility, in order to reduce the computational complexity and the possibility of misjudgment.

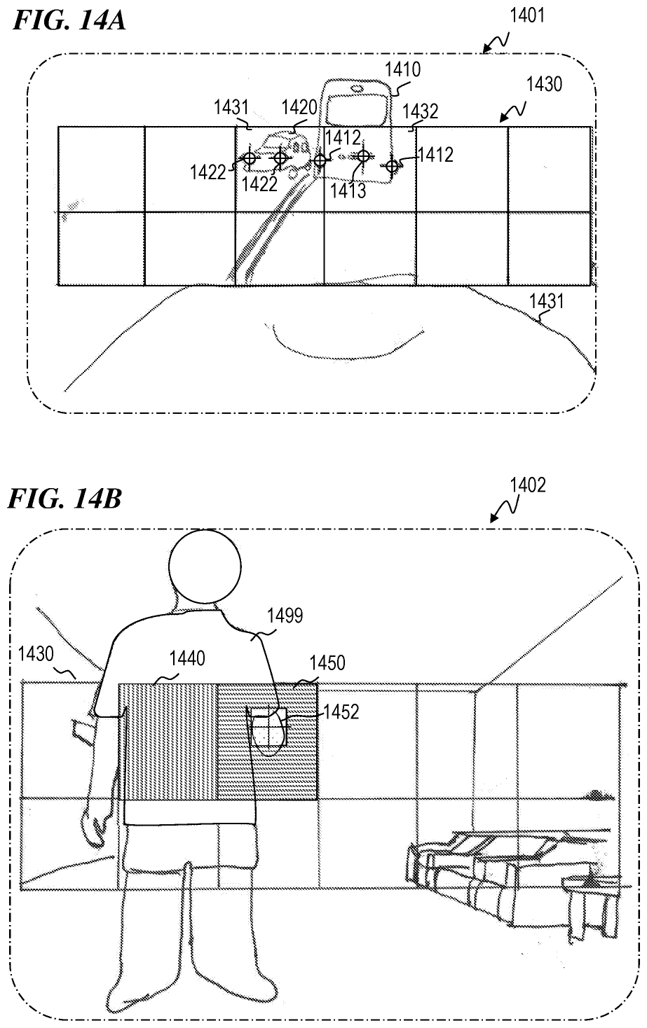

FIG. 14A is a schematic block diagram of a labeled region-of-interest (ROI) LiDAR image 1401, according to some embodiments of the present invention. In some embodiments, image 1401 includes a six-column by two-row array 1430 of rectangular portions 1430 of a roadway scene, with rectangular portion 1431 having an approaching car 1420 with its two headlights marked by crosses 1422 and rectangular portion 1432 having a departing coach bus 1410 with its two red taillights marked with crosses 1412 and another light marked with cross 1413. In this first case, when the lights (e.g., headlights and taillights) of other vehicles on the road nearby entered the ROI area, the position(s) of those vehicle(s) is/are marked with the blue squares and blue crosses in the image area through the recognition software, as shown in FIG. 14A representing a video frame of a driving documentary.

FIG. 14B is a schematic block diagram of ROI LiDAR image 1402, according to some embodiments of the present invention. In some embodiments, image 1402 includes a six-column by two-row array 1430 of rectangular portions of a scene, with rectangular portion 1440 (cross-hatched with vertical lines) having an associated LiDAR distance measurement, and rectangular portion 1450 (cross-hatched with horizontal lines) having a portion of person 1499 holding a flashlight marked with a crosses 1452.

For this second case, it was assumed that pedestrian 1499 and the pedestrian's flashlight(s) entered the ROI area, the position of a pedestrian and lights were marked with a square 1450 (cross-hatched with horizontal lines) with CCD image data, a square 1440 (cross-hatched with vertical lines) with associated LiDAR distance data, in which the ROI area was determined and marked by the recognition software, as shown in FIG. 14B in real-time. According to the design of some embodiments of the smart laser headlight, when the cars and pedestrians enter the ROI areas, the detected areas of smart laser headlight will be turned off. After the cars and pedestrians leave the ROI area, the smart laser headlight illumination for those areas will be turned on again. To demonstrate the vehicle detector to missed detections and false positives test, the video sequences were manually labelled. The video resolution was 960×540 when testing was conducted. The detection algorithm was evaluated by measuring bounding box intersection between annotation and the bounding box obtained by grouping detection. If the intersection percent was more than 70%, then the detection was proclaimed as valid. The experimental results showed the correct detections of seven-hundred-two (702), missed detections of ninety-seven (97), and false positives of thirty-one (31). Therefore, the detection rate was evaluated as 86%. The sensor fusion of combining the LiDAR detection and CCD image may cause the resulting information to have less uncertainty than the individual CCD source.

In summary, a new scheme of LiDAR embedded smart laser headlight module (LHM) was developed for autonomous driving. In comparison with most existing LiDAR sensors installed on the top of the vehicle in automotive applications, the advantages of the novel LiDAR-embedded laser headlight of the present invention are free of close-range dead angle (data unavailability at close range), prevention of dust collection and water corrosion, and easy set-up of the electrical system in the LiDAR sensors. In addition, the LHM 701 was fabricated using a unique high-reliability glass phosphor, which exhibited excellent thermal stability. The measured high-beam and low-beam patterns of the LHM and low-beam LEDHM well satisfied the ECE R112 class B regulation. In this study, by employing a smart algorithm, we demonstrated on/off control of portions of the headlight beams from smart headlights through the integration of the LiDAR detection and CCD image. The recognition rate of the objects was evaluated to be more than 86%. This proposed novel LiDAR embedded smart LHMs with a unique high-reliability glass phosphor-converter layer is a promising candidate for automotive use in the next-generation high-performance autonomous driving applications.

To promote versatility and road safety, smart headlights are being introduced. Due to the high cost, most systems are introduced to high-end vehicles, and as the price of smart headlights goes down in future, it is expected that smart headlights will be applied to high-volume, lower-end vehicles. In addition, more and more autonomous functions, such as self-breaking, car-following, parking assistance, etc., are being implemented, which requires imaging and non-imaging sensors to acquire the data for the environmental conditions such that appropriate action can be taken. To lower the cost of such systems, integration and sharing of components becomes important.

In some embodiments, the present invention provides an integrated smart headlight together with a LiDAR (“Light-based Detection And Ranging”) system using a single MEMS scanner. Such integration allows the sharing of the MEMS and other components, reducing the size and cost of the system.

FIG. 15 is a perspective-view diagram of a two-dimensional (2D) micro-electrical-mechanical system (MEMS) scanning mirror system 1501, according to some embodiments of the present invention. In some embodiments, 2D MEMS mirror system 1501 includes a mirror surface 1550 that is tiltable to a variable angle in the X direction relative to ring structure 1512 by electrostatic interdigitated angular actuators 1510 located on the lower-left edge and upper-right edge of ring structure 1512, and in turn, ring structure 1512 and its two actuators 1510 are tiltable to a variable angle in the Y direction relative to the overall structure of system 1501 by electrostatic interdigitated angular actuators 1520 located on the lower-right edge and upper-left edge of ring structure 1512.

FIG. 15 is a schematic drawing of a microphotograph of a typical MEMS device 1501 in which the mirror 1550 as shown can be rotated in two directions, namely, the X- and Y-directions. When a laser beam is directed at the mirror and is reflected towards a target, the target can be scanned by controlling the rotation of the mirror. Typical limits of the rotation angles are in the range of a few degrees to several tens (10's) of degrees in both directions. Most systems have different limits for each direction, and as a result, the outputs can be larger in the horizontal direction and smaller in the vertical directions, which will be suitable for most automotive applications.

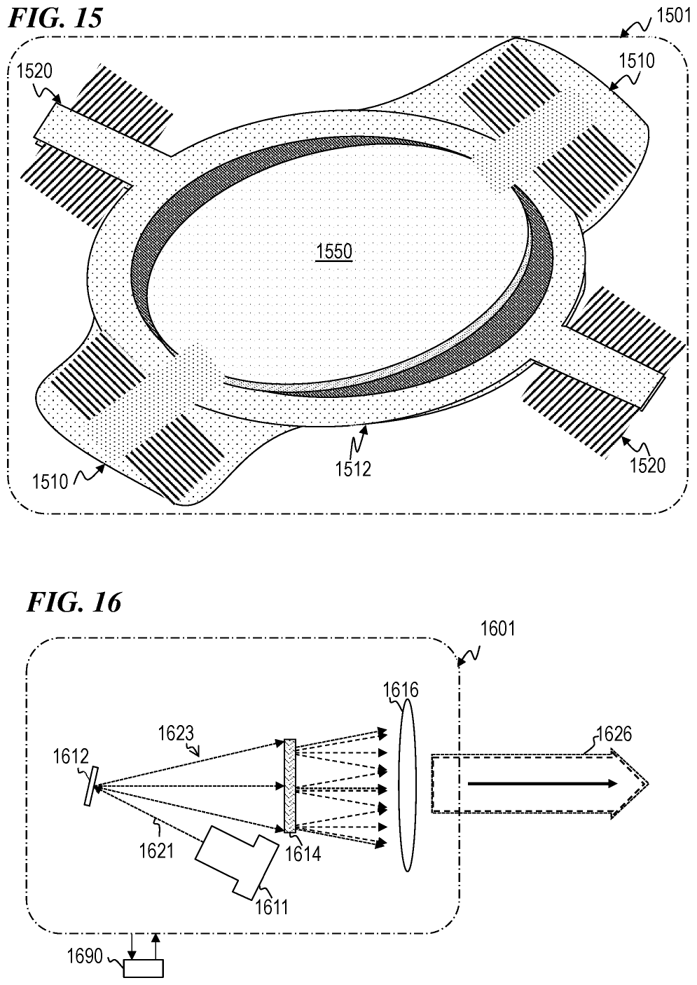

FIG. 16 is a side-view diagram of a smart headlight with scanned laser-pumped illumination system 1601 that utilizes a two-dimensional MEMS mirror system 1501, according to some embodiments of the present invention. In some embodiments, system 1601 includes a pump laser 1611 that emits a short-wavelength pump laser beam 1621 (e.g., in some embodiments, having a blue-color beam with a wavelength of 445 nm; or in other embodiments, other pump wavelengths in the range of 420 nm to 480 nm, or in the range of 430 nm to 460 nm, or in the range of 440 nm to 450 nm are used) that reflects from 2D MEMS scan mirror 1612 as a 2D scan pattern 1622 (e.g., in some embodiments, a raster scan in the X and Y directions) across the area of the major surface of the back (left-hand side) of phosphor plate 1614. In some embodiments, phosphor plate 1614 wavelength converts much of the scanned light of the pump laser beam 1622 to converted-wavelength light of longer wavelengths (e.g., in some embodiments, yellow light in a broad range of wavelength centered at about 580 nm), and that converted-wavelength light along with at least a portion of the shorter-wavelength pump light is focused by optics 1616 (e.g., in some embodiments, a lens or a plurality of lenses, one or more Fresnel lenses, or a curved reflector such as a parabolic or elliptical mirror, or diffractive optics such as a hologram or lithographically formed diffractive imager) into output headlight beam 1626. In some embodiments, laser 1611 is pulsed or amplitude modulated to vary the intensity of the light at each “pixel” subarea of phosphor plate 1614 and thus adjust the lateral size, shape and intensity of output beam 1626. In some embodiments, the duration of time that the scanned beam 1622 stays at each pixel location is variable, such that hot spot(s) can be created where the output beam is brighter at those locations since the beam is “ON” longer than at other areas. In some embodiments, the intensity (optical power) of scanned beam 1622 at each pixel location is variable, such that hot spot(s) can be created where the output beam is brighter at those locations since the pumping beam is brighter there than at other areas.

FIG. 16 shows an example of a scanning-laser phosphor smart headlight 1601. A focused laser beam 1621 with the focus adjusted to be at the phosphor plate 1614 such that a smallest spot with the best resolution is obtained. As the MEMS mirror 1612 is scanning, the focused spot will be scanned as scanned beam 1623 across an area on the phosphor plate 1614, producing a moving light spot. In some embodiments, the laser 1611 is turned ON/OFF (i.e., pulsed), and/or amplitude modulated in intensity, and is synchronized with the scanning such that the desired spatial pattern is obtained for output beam 1626. The output pattern of wavelength-converted emitted yellow light from the phosphor plate 1614, along with an unconverted portion of blue laser light 1623, is projected onto the roadway using a projection lens 1616 (such as shown in FIG. 16). Controller 1690 controls the headlight pattern. Examples of such patterns include low beam, high beam, warning symbols (e.g., symbols superimposed as computer graphics onto the headlight pattern and/or instead of the headlight pattern as head-up displayed vehicle speed, turn directions, maps, vehicle status, or the like), etc.

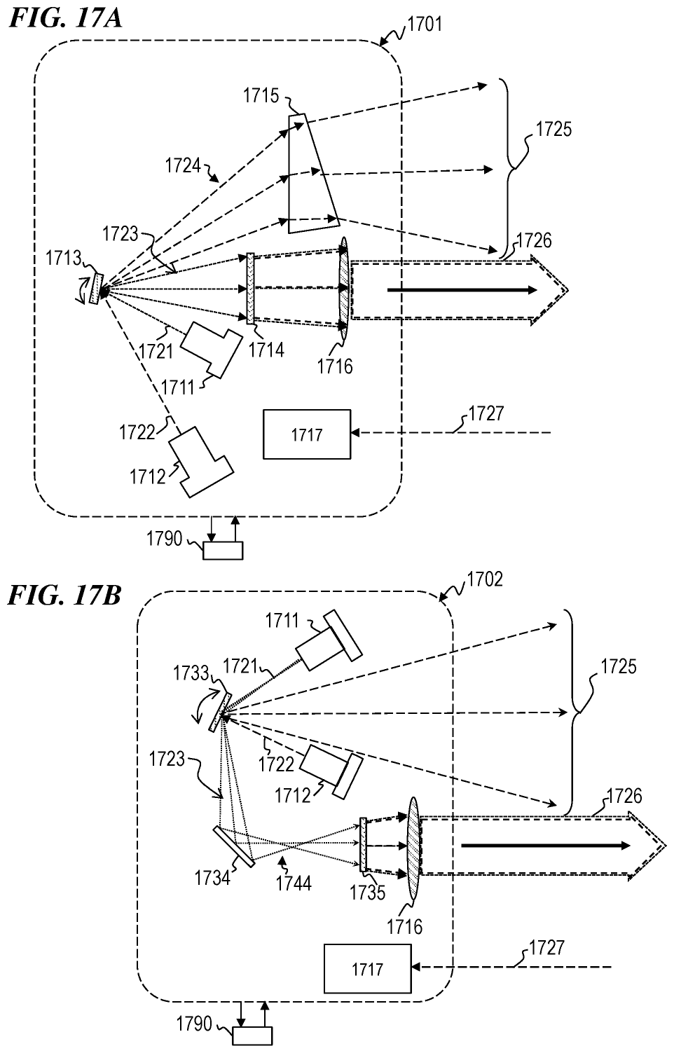

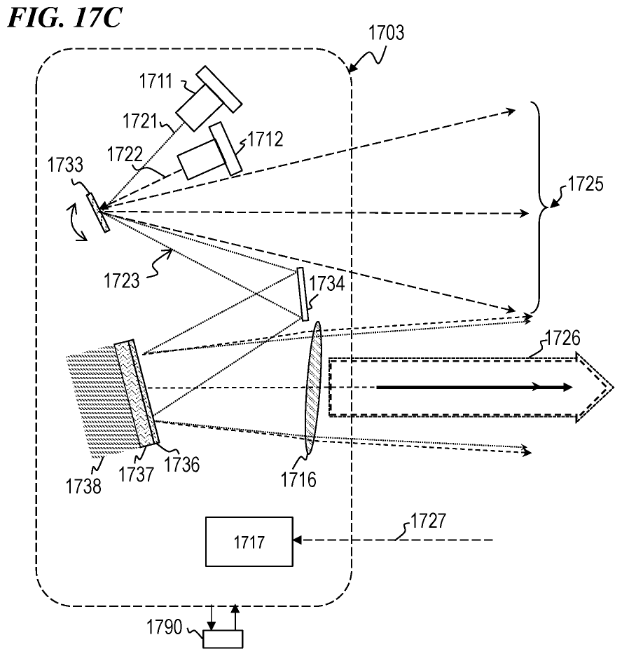

FIG. 17A is a side-view diagram of a combined LiDAR and smart headlight with scanned laser-pumped illumination system 1701 that utilizes a two-dimensional MEMS mirror system 1501, according to some embodiments of the present invention. In some embodiments, system 1701 includes a pump laser 1711 that emits a short-wavelength (indicated by the small dots in the lines of this light in FIG. 17A) pump laser beam 1721 that reflects from 2D MEMS scan mirror 1713 as a 2D scan pattern 1723 across the area of phosphor plate 1714. In some embodiments, phosphor plate 1714 wavelength converts much of the scanned light of the scanned pump laser beam 1723 to converted-wavelength light of longer wavelengths (indicated by the medium-length dashes in the lines of this light in FIG. 17A), and that converted-wavelength light along with at least a portion of the shorter-wavelength pump light is focused by optics 1716 into output headlight beam 1726. In some embodiments, pump laser 1711 is pulsed or amplitude modulated to vary the intensity of the light at each “pixel” subarea of phosphor plate 1714 and thus adjust the lateral size, shape and intensity of output beam 1726. The above headlight-generating aspects of system 1701 match the corresponding headlight-generating aspects of system 1601 of FIG. 16. In addition, system 1701 includes LiDAR scanning functions obtained from LiDAR laser 1712 that emits a LiDAR laser beam 1722 (in some embodiments, having an infrared (IR) wavelength (indicated by the long-length dashes in the lines of this light in FIG. 17A) of, e.g., 905 nm or 920 nm) that impinges onto the same 2D MEMS scan mirror 1713 as used to scan the headlight-generating pump laser 1711 to form pump laser beam scan pattern 1723, but IR LiDAR laser beam 1722 is at a different, shallower angle to 2D MEMS scan mirror 1713 as compared to pump laser beam 1721, so the LiDAR scan pattern 1724 comes off at a 2D range of shallower angles 1724, and this LiDAR scan pattern 1724 is redirected by redirection optics such as prism 1715 to form the output LiDAR scan pattern 1725. The reflected LiDAR signal 1727 is received by detector 1717, and controller 1790 uses the delay between each output laser pulse and the received reflection to determine distances to each X-Y angle/position of the output scan pattern 1725. In some embodiments, controller 1790, which controls the components described above, also controls the size, shape, direction, intensity, superimposed symbols, and/or the like, of headlight pattern.

FIG. 17B is a side-view diagram of a combined LiDAR and smart headlight with scanned laser-pumped illumination system 1702 that utilizes a two-dimensional MEMS mirror system 1501 but avoids redirection optics 1715 for the scanned LiDAR output beam 1725, according to some embodiments of the present invention. In some embodiments, system 1702 has the pump laser beam impinging on 2D MEMS scan mirror 1733 to form pump-beam scan pattern 1723 propagating initially downward, then reflecting from stationary mirror 1734 (or other suitable redirection optics such as a diffraction grating) to form scan pattern 1744 that impinges on phosphor plate 1735. Other aspects of system 1702 are the same as corresponding structures and functions in system 1701.

FIG. 17C is a side-view diagram of a combined LiDAR and smart headlight with scanned laser-pumped illumination system 1703 that utilizes a two-dimensional MEMS mirror system 1501 but avoids redirection optics for the scanned LiDAR output beam and includes a heatsink 1738 on the phosphor plate 1737, according to some embodiments of the present invention. In some embodiments, the functions and structures of system 1703 are the same as corresponding structures and functions in system 1702, except that the scanned pump beam impinges on a front major surface of phosphor plate 1737 in system 1703 rather than the back major surface of phosphor plate 1713 in system 1702. In some embodiments, this allows phosphor plate 1737 to be mounted on a heatsink 1738 to better dissipate waste thermal energy of the wavelength-conversion process. In some embodiments, this diffuser plate 1736 or the like is mounted on or formed into the front surface of phosphor plate 1737 such that unconverted blue light from the pump beam combines with the wavelength-converted blue light from the phosphor plate 1737 to form output headlight beam 1726. In some embodiments, lens 1716 is tilted to compensate for the tilt of phosphor plate 1737 and diffusion plate 1736, such that the major surface of phosphor plate 1737 is at the focal plane of the scene being illuminated by output headlight beam 1726.

Referring again to FIG. 17A, an embodiment of the present invention is shown in which an infrared LiDAR laser beam 1721 is used together with the MEMS mirror 1713, producing the scanning output beam portion 1725 of the LiDAR system. The infrared LiDAR laser beam 1722 is placed at a different angle from the pump laser beam 1721 used for the headlight, relative to the MEMS mirror 1713. Since the same MEMS mirror 1713 is used, as the headlight pump laser beam 1721 is being scanned to form scan pattern 1722, the LiDAR laser beam 1723 is also scanned to form scan pattern 1724, but at a different output angle, as shown. In order to have the LiDAR beam directed toward the output direction 1725, in some embodiments, one or more wedge prisms 1715 can be used, providing the needed deviations redirecting the scanned beam 1724 to the output direction of scanned pattern 1725.

Under normal operation, the infrared LiDAR laser 1711 is driven with a very short pulse. As the infrared LiDAR laser beam is reflected by the target, the returned LiDAR signal 1727 is received by the receiver detector 1717. The time difference between the transmitted infrared LiDAR laser pulse and the returned pulse is used to calculate the distance of the target. As the scanned LiDAR laser beam 1725 is scanning the targets around the automobile, the detector 1717 will determine the distance of each point of the targets scanned by the LiDAR laser beam, forming a three-dimensional (3D) data representing a digital picture of the targets. In some embodiments, this 3D distance data is used to adjust the shape, size, direction and/or intensity or headlight beam 1726.

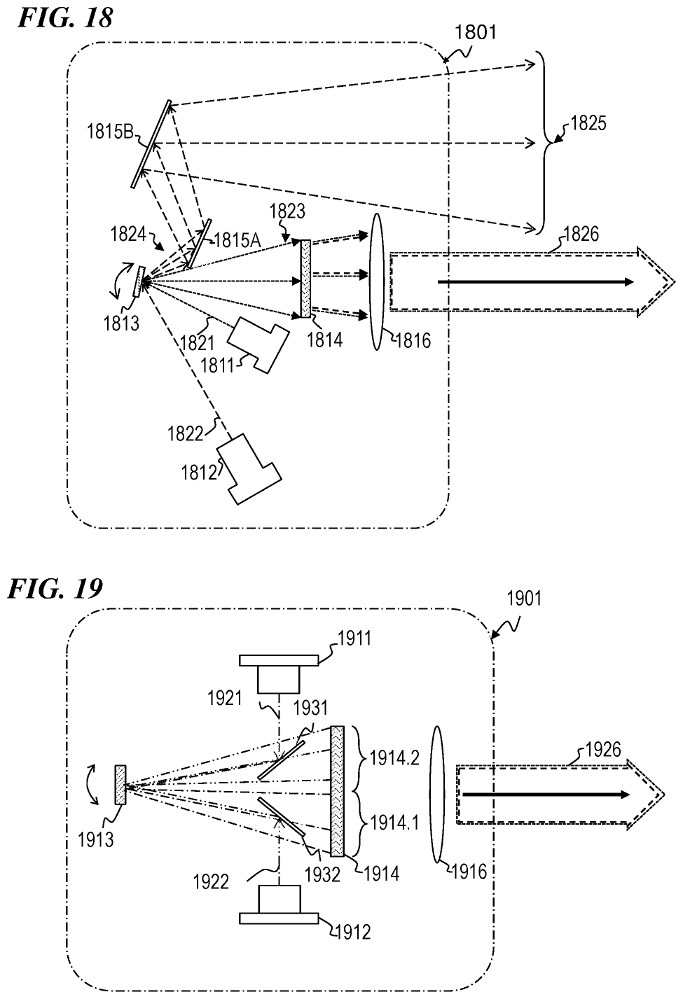

FIG. 18 is a side-view diagram of a combined LiDAR and smart headlight with scanned laser-pumped illumination system 1801 that utilizes a two-dimensional MEMS mirror system 1501, according to some embodiments of the present invention. In some embodiments, system 1801 includes a pump laser 1811 that emits a short-wavelength pump laser beam 1821 that reflects from 2D MEMS scan mirror 1813 as a 2D scan pattern 1823 across the area of phosphor plate 1814. In some embodiments, phosphor plate 1814 wavelength converts much of the scanned light 1823 of the pump laser beam 1821 to converted-wavelength light of longer wavelengths, and that converted-wavelength light (indicated by the medium-length dashes in the lines of this light in FIG. 18) along with at least a portion of the shorter-wavelength pump light (indicated by the small dots in the lines of this light in FIG. 18) is focused by optics 1816 into output headlight beam 1826. In contrast to the prism(s) 1715 of system 1701 in FIG. 17A, system 1801 uses mirrors 1815A and 1815B as the redirection optics to generate the scanned output LiDAR beam 1825. Other aspects, structures and functions of system 1801 are the same as the corresponding aspects, structures and functions of system 1701.

Instead of using one or more prisms 1715 as shown in FIG. 17A, in other embodiments two reflectors 1815A and 1815B are used, as shown in FIG. 18, which shows another embodiment of the present invention. The LiDAR laser beam 1821 is scanned by the 2D-MEMS mirror 1813 and the scanned pattern 1824 is reflected by two additional reflectors 1815A and 1815B in the upper portion of FIG. 18 such that the beam 1825 is directed towards the output direction. In addition, one or both of the additional reflectors 1815A and 1815B can be concave or convex such that the scanning angle (in X and/or Y directions) and beam divergence (in X and/or Y directions) can be adjusted.

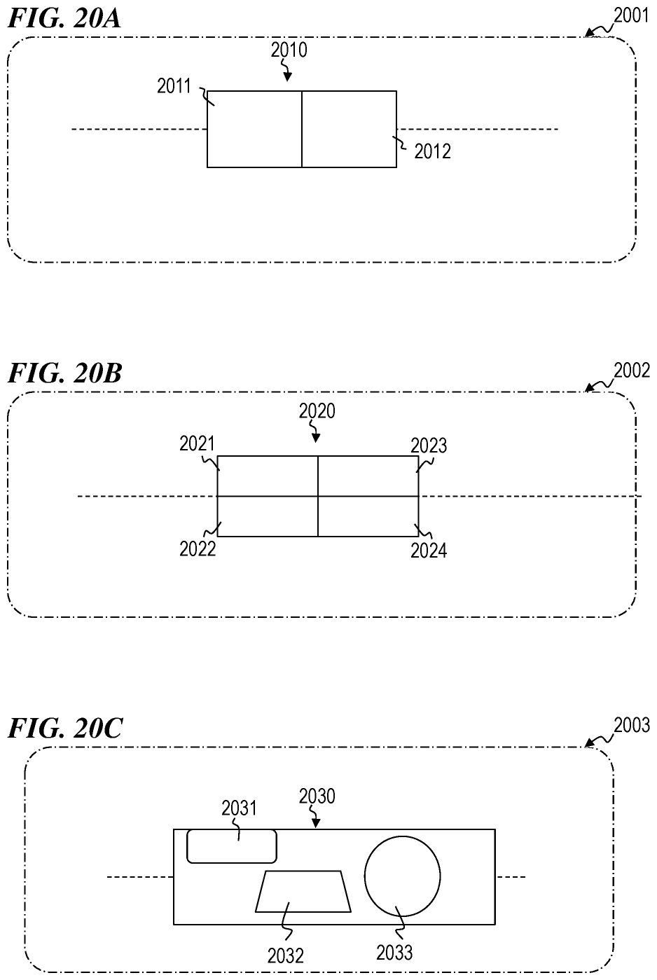

FIG. 19 is a side-view diagram of a combined low-beam/high-beam smart headlight with scanned laser-pumped illumination system 1901 that utilizes a two-dimensional MEMS mirror system 1501 for scanning mirror 1913, according to some embodiments of the present invention. In some embodiments, system 1901 uses a plurality of pump lasers 1911 and 1912, and optionally a plurality of mirrors 1931 and 1932 to direct pump light toward 2D MEMS scan mirror 1913 from a plurality of peripheral angles. In some embodiments, each pump laser beam is scanned across a different area of phosphor plate 1914 (e.g., as shown here, pump laser beam 1921 with a dash-single-dot line is scanned by mirror 1913 across area 1914.1 of phosphor plate assembly 1914, while simultaneously pump laser beam 1922 with a dash-double-dot line is scanned by mirror 1913 across area 1914.2 of phosphor plate assembly 1914 Two beams 1921 and 1922 are shown here, with two corresponding areas 1914.1 and 1914.2 (corresponding to areas 2011 and 2012 in the front view of FIG. 20A), but in other embodiments, a larger number of beams are directed from circumferential angles surrounding the circumference of 2D MEMS scan mirror 1913. In some embodiments, a LiDAR beam such as shown in FIGS. 17A and 18, for example, is also scanned by the same 2D MEMS scan mirror 1913 in a corresponding manner as shown in FIGS. 17A and 18. In some embodiments, the multi-laser scanned laser-pumped illumination system 1901 is used in any of the other systems herein that are described having single pump-lasers directed at a single scan mirror and scanned across a phosphor plate. Output beam 1926 having a headlight illumination shape (which includes a portion of unconverted short-wavelength light indicated by dotted line and wavelength-converted light indicated by dashed line) has a higher number of pixels for a given modulation frequency imposed on the plurality of lasers 1911-1912, since each of the plurality of scan areas 1914.1-1914.2 has the number of pixels that would be produced by a single pump laser being modulated at the given modulation frequency. See FIGS. 20A and 20B for examples of phosphor plate assemblies having a plurality of scan areas, each respective one of which is scanned, in some embodiments, by a respective pump laser beam, all directed at a single 2D MEMS mirror 1913. In some embodiments, a single phosphor plate is used for phosphor plate assembly 1914, while in other embodiments, a plurality of phosphor plates are arranged either edge-to-edge (e.g., with two separate phosphor plates forming the two areas 2011 and 2012 of FIG. 20A, or with two, four or more separate phosphor plates forming the four areas 2021, 2022, 2023 and 2024 of FIG. 20B), or stacked on one another as shown in FIG. 23, with a third laser supplying the additional front-side beam 2322 (see FIG. 23) to provide a hot spot in the output beam 1926 of FIG. 19.

Thus, in order to increase the output power, some embodiments use two or more pump lasers 1911-1912 to provide the laser excitation for the phosphor plate 1914. For a two-laser system as shown in FIG. 19, since the 2D-MEMS mirror 1913 is common to both lasers beams 1911 and 1912, the area of the phosphor plate 1914 is divided into two sub-areas 1914.1 and 1914.2, such that each sub-area is scanned by its respective laser 1911 and 1912. In this case, two scanned laser spots are used, instead of one scanned laser spot as shown in FIGS. 16-18, doubling the output power of the system. In some embodiments, the phosphor plate 1914 is divided into two areas 1914.2 and 1914.2 (such as area 2011 and 2012 of phosphor plate 2010 of FIG. 20A when plate 2010 is used for plate 1914). As shown in FIG. 19, the output beam 1921 of laser 1911 is reflected by the mirror 1931 toward near the middle of the area 2011 of FIG. 20A, such that when the 2D-MEMS mirror is scanning, the full area of the area 2011 is scanned. Similarly, the output beam 1922 of laser 1912 is reflected by the mirror 1932 toward near the middle of the area 2012 of FIG. 20A, such that when the 2D-MEMS mirror 1913 is scanning, the full area of the area 2012 is scanned. As shown in FIG. 19, the laser 1901, laser 1902, mirror 1931, and mirror 1932 are placed at a different plane reference to the plane of the 2D-MEMS mirror 1913 and the phosphor plate 1914. Besides having a large area for phosphor-plate assembly 1914, the number of pixels is also increased.

FIG. 20A is a front-view diagram 2001 of a phosphor plate 2010 usable, for example, for phosphor plate assembly 1914 in combined low-beam/high-beam smart headlight with scanned laser-pumped illumination system 1901, showing the two scanned areas 2011 and 2012 side-by-side, according to some embodiments of the present invention. To further increase the power, more lasers can be used, with each laser directed towards its own area at the phosphor plate 2001.

FIG. 20B is a front-view diagram 2002 of a phosphor plate 2020 usable, for example, for phosphor plate assembly 1914 in combined low-beam/high-beam smart headlight with scanned laser-pumped illumination system 1901, according to some embodiments of the present invention. FIG. 20B shows phosphor plate 2020 with four areas for use with four lasers, increasing the power to four times. In some embodiments, the respective four laser beams are placed appropriately such that each beam is directed to scan its own respective area 2021, 2022, 2023 or 2024 using the same single 2D-MEMS 1913 of FIG. 19. In still other embodiments, a larger number of lasers are used to impinge on a corresponding number of areas on the phosphor plate 2002 used for phosphor-plate assembly 1914.

FIG. 20C is a front-view diagram 2003 of a phosphor plate 2030 usable, for example, in combined low-beam/high-beam smart headlight with scanned laser-pumped illumination system 1901, according to some embodiments of the present invention. FIG. 20C shows an embodiment in more general applications in which each area 2031, 2032, and 2033 can be connected to another or be separate from each other, and have different sizes and shapes. In some embodiments, the scanning of the various areas is done using a single laser simply by programing, or, in other embodiments, using multiple lasers, each exciting a different region on the phosphor plate or a combination of both to scan areas 2031, 2032, 2033 (and, in other embodiments, additional areas), as an example.

In a similar fashion, not shown, a plurality of infrared (IR) LiDAR lasers can be used at different circumferential positions, pointing at the same 2D-MEMS mirror, such that multiple sets of scanning LiDAR beam(s), each set having one or more laser beam(s), can be produced. Prisms, diffraction optics, and/or reflectors can be used to direct each set of scanning LiDAR beam(s) to the desired direction, and multiple LiDAR detectors can be used, one or more LiDAR detector(s) for each set of scanning LiDAR beam(s), forming multiple 3D digital pictures with measured distances for each X and Y angle/position from different (possibly somewhat overlapping) directions based on the directions of the scanning LiDAR beams.

In some embodiments, to provide reduced cross-talk between the sets of scanning LiDAR beams, different LiDAR laser-beam wavelengths are used for the respective output LiDAR beams and the respective LiDAR detector's wavelength filters, wherein a narrow-band filter can be used in front of each LiDAR detector for detecting the appropriate return LiDAR signals from the LiDAR laser of the given wavelength, forming the proper digital pictures.

There is another feature of a smart headlight that is desirable, but usually limited by the power-handling capacity of the phosphor plate. This is the formation of a hot spot, a high-intensity area on the phosphor plate such that it can be projected onto the roadway with extended range. With the 2D-MEMS mirror, the scanning can be controlled such that the beam can stay at the desired position for a long time, or the laser can be driven at higher power at a given position, producing the “hot spot” required (the hot spot being an area of the output headlight beam that has increased intensity relative to the other areas of the output headlight beam), as long as the phosphor plate is not damaged by the higher intensity. For certain applications and intensity requirements, the property of crystal-phosphor materials or glass-phosphor plates that they withstand high temperatures is desirable and/or required. But the transparent property of crystal phosphor allows diffusion of light and does not allow the formation of high-resolution spots.

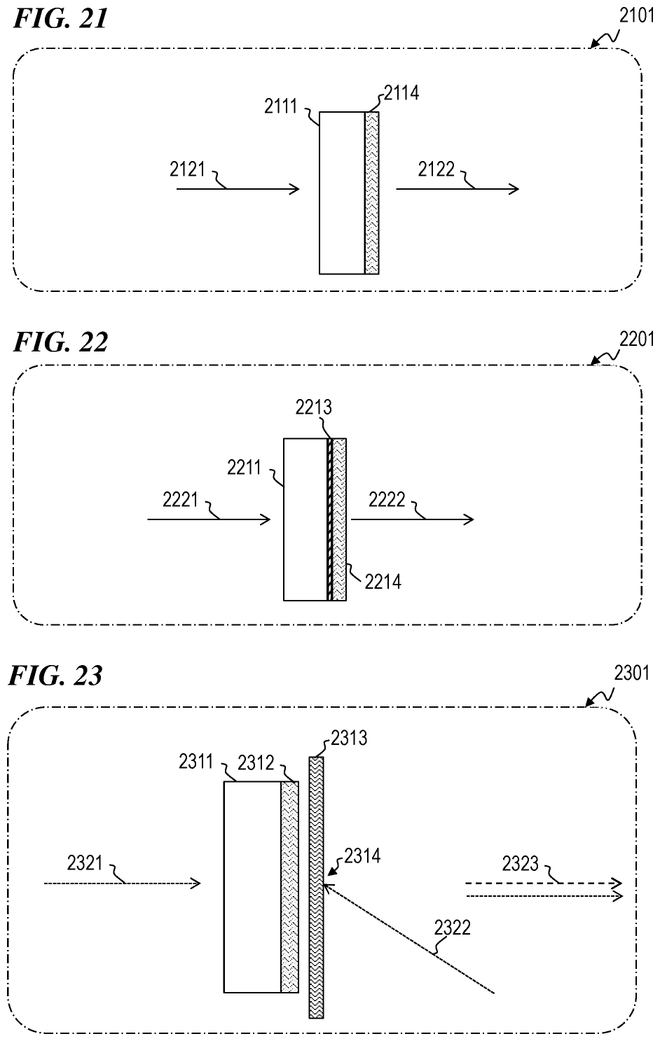

FIG. 21 is a cross-section-view diagram of a phosphor plate 2101 usable, for example, in combined low-beam/high-beam smart headlight with scanned laser-pumped illumination systems such as 1601, 1701, 1702, 1703, 1801 or 1901, according to some embodiments of the present invention. In some embodiments, a standard phosphor plate 2101 is made with a thin layer 2114 of organic phosphor, such as silicone phosphor, placed on top of a transparent substrate 2111. In some embodiments, a portion of a short-wavelength (such as blue light) input beam 2121 is wavelength-converted to one or more longer wavelengths (such as yellow light). In some embodiments, another portion of the short-wavelength (such as blue light) input beam 2121 is converted and passes through as unconverted wavelengths of pump light (such as blue light), and the combination of wavelength-converted and unconverted pump light 2122 forms white light of the headlight beam. The thickness and concentration of such organic-phosphor layers 2114 are controlled by fabrication processes such as silk screening, heating, etc. The power-handling capacity of such a structure is limited because the organic materials burn at high temperatures caused when the high-power, focused laser beam is absorbed.

FIG. 22 is a cross-section-view diagram of a phosphor plate 2201 usable, for example, in combined low-beam/high-beam smart headlight with scanned laser-pumped illumination systems such as 1601, 1701, 1702, 1703, 1801 or 1901, according to some embodiments of the present invention. In some embodiments, phosphor plate 2201 includes a piece of glass phosphor 2214 bonded to a transparent substrate 2211 by glass-to-glass bonding or by high-temperature optical glue 2213 with low absorption such that a much higher laser intensity can be handled without producing damage, allowing high-power operations. In some embodiments, the thickness of the glass phosphor 2214 is adjusted by polishing after bonding. In some embodiments, a thickness of the glass phosphor portion 2214 as low as a few tens (10's) of microns can be fabricated.

FIG. 23 is a cross-section-view diagram of a phosphor plate assembly 2301 usable, for example, in combined low-beam/high-beam smart headlight with scanned laser-pumped illumination systems such as 1601, 1701, 1702, 1703, 1801 or 1901, according to some embodiments of the present invention. In some embodiments, phosphor plate assembly 2301 includes a piece of phosphor 2312 (e.g., low-temperature phosphor layer) bonded to a transparent substrate 2311, and a glass or ceramic phosphor plate 2313 (optionally mounted on a transparent substrate (not shown) by glass-to-glass bonding or by high-temperature optical glue (not shown) with low absorption such that a much higher laser intensity can be handled without producing damage, allowing high-power operations. In some embodiments, a combination of a low-temperature phosphor 2312 and a high-temperature-capable crystal phosphor 2313 are present together, forming a phosphor plate assembly that can be used to produce a hot-spot headlight. A secondary laser beam 2322 is used to pump a center portion of phosphor plate 2313, creating a hot spot at the crystal-phosphor plate 2313 where it has a much higher power capacity. The crystal phosphor 2313 is transparent relative to the emitted and transmitted light from phosphor 2312 and has minimal effect on the emission from the original organic-phosphor layer emission of phosphor 2312. Since the hot spot is for distance illumination, it does not require a high-resolution spot for standard smart headlight functions.

In some embodiments, the present invention provides an apparatus that includes: a first single-mirror MEMS scanner; a laser-phosphor smart headlight that includes a blue-light laser and a target phosphor plate; and a LiDAR laser system that includes a pulsed infrared laser and redirection optics, wherein the laser-phosphor smart headlight and the LiDAR laser system both use the first single-mirror MEMS scanner to reflect respective laser beams of the blue-light laser onto the target phosphor plate and the pulsed infrared laser towards the redirection optics.

In some embodiments, the present invention provides a first apparatus that includes: a LiDAR device, the LiDAR device including: a laser (e.g., 420 of FIG. 4, 520 of FIG. 5, 620 of FIG. 6) that outputs a pulsed LiDAR laser signal; a DMD (e.g., 412 of FIG. 4, 512 of FIG. 5, 612 of FIG. 6) having a plurality of individually selectable mirrors arranged on a first major surface of the DMD; first optics (e.g., lens 430 of FIG. 4, 530 of FIG. 5, 630 of FIG. 6) configured to capture light from an entire scene and to focus the captured light to a focal plane located at the first surface of the DMD; a light detector (e.g., 418 of FIG. 4, 514 of FIG. 5, 614 of FIG. 6); and a first light dump (e.g., 412 of FIG. 4, 518.2 of FIG. 5, 618 of FIG. 6), wherein each respective one of the plurality of mirrors of the DMD is switchable to selectively reflect a respective portion of the captured light to one of a plurality of angles including a first angle that directs the reflected light toward the light detector and a second angle that directs the reflected light toward the first light dump.

Some embodiments of the first apparatus further include: an optical-spread element configured to spread the pulsed LiDAR laser signal so as to illuminate the entire scene.

Some embodiments of the first apparatus further include: a scan mirror (e.g., 460 of FIG. 4, 560 of FIG. 5) configured to selectively point a narrow beam of the pulsed LiDAR laser signal to a plurality of successively selected XY angles; and a controller (e.g., 490 of FIG. 4, or 590 of FIG. 5) operatively coupled to the DMD to control a tilt direction of each one of the plurality of mirrors of the DMD and operatively coupled to the scan mirror to control the successively selected XY angles toward which the narrow beam of the pulsed LiDAR laser is pointed, wherein the controller controls the plurality of individually selectable mirrors of the DMD to direct light from those mirrors at one or more selected XY locations on the DMD corresponding to the plurality of successively selected XY angles to the light detector and to direct light from others of the plurality of individually selectable mirrors toward the first light dump.

In some embodiments of the first apparatus, the first light dump includes a heat sink having black non-reflective surface.

Some embodiments of the first apparatus further include: a second light dump (e.g., 518.1 of FIG. 5); a scan mirror (e.g., 560 of FIG. 5) configured to selectively point a narrow beam of the pulsed LiDAR laser signal toward a plurality of successively selected XY angles; and a controller (e.g., 590 of FIG. 5) operatively coupled to the DMD to control selectable tilt directions of each one of the plurality of mirrors of the DMD and operatively coupled to the scan mirror to control the successively selected XY angles toward which the narrow beam of the pulsed LiDAR laser is pointed, wherein the plurality of individually selectable mirrors of the DMD are configured to direct light from those mirrors corresponding to the plurality of successively selected XY angles to the light detector and to direct light from others of the plurality of individually selectable mirrors toward the first light dump; and a scene-illumination source of light operatively configured to direct scene-illumination light onto the DMD, wherein the plurality of individually selectable mirrors of the DMD is configured to direct scene-illumination light from those mirrors corresponding to a plurality of simultaneously selected XY angles toward the first optics, wherein the first optics configured to output selected portions of the scene-illumination light for output as a headlight beam, and wherein the plurality of individually selectable mirrors of the DMD is configured to direct light from others of the plurality of individually selectable mirrors toward the second light dump. In some such embodiments, of the first apparatus, the selectable tilt directions of each one of the plurality of mirrors of the DMD includes a first tilt angle relative to the first major surface of the DMD and a second tilt angle relative to the first major surface of the DMD, and wherein the first tilt angle directs light from the scene toward the light detector and the second tilt angle directs light from the scene toward the first light dump. In some embodiments, the first tilt angle directs light from the scene-illumination source of light toward the scene and the second tilt angle directs light from the scene-illumination source of light toward the second light dump. In some embodiments, the scene-illumination source of light is pulsed such that the pulses from the scene-illumination source of light are interleaved in time with the pulsed LiDAR laser signal. In some embodiments, the selectable tilt directions of each one of the plurality of mirrors of the DMD includes a first tilt angle relative to the first major surface of the DMD and a second tilt angle relative to the first major surface of the DMD, and wherein the first tilt angle directs light from the scene toward the light detector and the second tilt angle directs light from the scene toward the first light dump, and wherein the first tilt angle is a positive angle relative to a reference line on the first major surface of the DMD and the second tilt angle is a negative angle relative to the reference line on the first major surface of the DMD.

Some embodiments of the first apparatus further include: a controller operatively coupled to the DMD to control a tilt direction of each one of the plurality of mirrors of the DMD, wherein the pulsed LiDAR laser signal is a wide-angle beam that is spread across the entire scene, and wherein the controller controls the plurality of individually selectable mirrors of the DMD to direct light from those mirrors successively selected at one or more selected XY locations on the DMD corresponding to the plurality of successively selected XY angles to the light detector and to direct light from others of the plurality of individually selectable mirrors toward the first light dump.

Some embodiments of the first apparatus further include: a controller operatively coupled to the DMD to control a tilt direction of each one of the plurality of mirrors of the DMD, wherein the pulsed LiDAR laser signal is a wide-angle beam that is spread across the entire scene, and wherein the controller controls the plurality of individually selectable mirrors of the DMD to direct light from those mirrors successively selected at one or more selected XY locations on the DMD corresponding to the plurality of successively selected XY angles to the light detector, and to direct light from others of the plurality of individually selectable mirrors toward the first light dump, and wherein how many of the mirrors that are selected to direct light to the light detector is variable based on signal strength.

In some embodiments, the present invention provides a first method that includes: outputting a pulsed LiDAR laser signal from a laser toward a scene; collecting and focusing reflected light from the pulsed LiDAR laser signal onto a focal plane located at a first surface of a DMD having a plurality of individually selectable mirrors arranged on the first major surface of the DMD; controlling a first selected subset of plurality of individually selectable mirrors to reflect a selected portion of the collected and focused reflected light from the pulsed LiDAR laser signal onto a light detector; and controlling a second selected subset of plurality of individually selectable mirrors to reflect a remaining portion of the collected and focused reflected light from the pulsed LiDAR laser signal onto a first light dump.

Some embodiments of the first method further include controlling a scan mirror to selectively point a narrow beam of the pulsed LiDAR laser signal to a plurality of successively selected XY angles; and controlling a tilt direction of each one of the plurality of mirrors of the to direct light from those mirrors at one or more selected XY locations on the DMD corresponding to the plurality of successively selected XY angles to the light detector, and to direct light from others of the plurality of individually selectable mirrors toward the first light dump.

In some embodiments of the first method, the first light dump includes a heat sink having black non-reflective surface.

Some embodiments of the first method further include controlling a scan mirror to selectively point a narrow beam of the pulsed LiDAR laser signal toward a plurality of successively selected XY angles; controlling a tilt direction of each one of the plurality of mirrors of the to direct light from those mirrors at one or more selected XY locations on the DMD corresponding to the plurality of successively selected XY angles to the light detector, and to direct light from others of the plurality of individually selectable mirrors toward the first light dump; directing scene-illumination light onto the DMD; controlling the plurality of individually selectable mirrors of the DMD to direct scene-illumination light from those mirrors corresponding to a plurality of simultaneously selected XY angles toward the scene; and controlling selected ones of the DMD output selected portions of the scene-illumination light as a headlight beam, and controlling others of the plurality of individually selectable mirrors do direct other portions of the scene-illumination light toward a second light dump. In some such embodiments of the first method, the selectable tilt directions of each one of the plurality of mirrors of the DMD includes a first tilt angle relative to the first major surface of the DMD and a second tilt angle relative to the first major surface of the DMD, and wherein the first tilt angle directs light from the scene toward the light detector and the second tilt angle directs light from the scene toward the first light dump. In some embodiments of the first method, the selectable tilt directions of each one of the plurality of mirrors of the DMD includes a first tilt angle relative to the first major surface of the DMD and a second tilt angle relative to the first major surface of the DMD, and wherein the first tilt angle directs light from the scene-illumination source of light toward the scene and the second tilt angle directs light from the scene-illumination source of light toward the second light dump. In some embodiments of the first method, the scene-illumination source of light is pulsed such that the pulses from the scene-illumination source of light are interleaved in time with the pulsed LiDAR laser signal.

In some embodiments of the first method, the selectable tilt directions of each one of the plurality of mirrors of the DMD includes a first tilt angle relative to the first major surface of the DMD and a second tilt angle relative to the first major surface of the DMD, and wherein the first tilt angle directs light from the scene toward the light detector and the second tilt angle directs light from the scene toward the first light dump, and wherein the first tilt angle is a positive angle relative to a reference line on the first major surface of the DMD and the second tilt angle is a negative angle relative to the reference line on the first major surface of the DMD.

Some embodiments of the first method further include spreading the pulsed LiDAR laser signal into a wide-angle beam that is spread across the entire scene, and controlling a tilt direction of each one of the plurality of mirrors of the DMD to direct light from those mirrors successively selected at one or more selected XY locations on the DMD corresponding to the plurality of successively selected XY angles to the light detector and to direct light from others of the plurality of individually selectable mirrors toward the first light dump.

Some embodiments of the first method further include spreading the pulsed LiDAR laser signal into a wide-angle beam that is spread across the entire scene, and controlling a tilt direction of each one of the plurality of mirrors of the DMD to direct light from those mirrors successively selected at one or more selected XY locations on the DMD corresponding to the plurality of successively selected XY angles to the light detector and to direct light from others of the plurality of individually selectable mirrors toward the first light dump, and wherein how many of the mirrors that are selected to direct light to the light detector is variable based on signal strength.

In some embodiments, the present invention provides a second apparatus (e.g., 701 of FIG. 7) for automatically adjusting a spatial shape of a vehicle headlight beam as projected onto a scene. This second apparatus includes: a first pump-light source that generates a first pump light (such as a pump laser and/or other pump-light source generating pump light from one or more LEDs or other sources of pump light); a first plate made of glass having a phosphor therein operatively coupled to receive the first pump light and to emit wavelength-converted light from areas of the glass first plate illuminated by the first pump light; projection optics operatively coupled to receive the wavelength-converted light from the first plate and an unconverted portion of the first pump light and configured to project a headlight beam toward the scene, wherein the headlight beam is based on the received wavelength-converted light and the unconverted portion of the first pump light; a digital imager configured to obtain image data of the scene; a LiDAR sensor configured to obtain a plurality of distance measurements of objects in the scene; and control logic operatively coupled to receive and combine the image data and the plurality of distance measurements and configured, based on the combined image data and distance measurements, to generate headlight control data that is used to adjust the spatial shape of the headlight beam.

In some embodiments of the second apparatus, the first pump-light source includes a first pump laser. Some embodiments of this second apparatus further include: a second pump laser that generates a second pump laser beam; and a second plate having a phosphor therein operatively coupled to receive the second pump laser beam and to emit wavelength-converted light from areas of the second plate illuminated by the second pump laser beam, wherein the wavelength-converted light from the second plate propagates to the projection optics and is combined with the wavelength-converted light from the glass first plate.

In some embodiments of the second apparatus, the projection optics includes a parabolic reflector.

In some embodiments of the second apparatus, the projection optics includes an elliptical reflector.

In some embodiments of the second apparatus, the projection optics includes: an elliptical reflector configured to generate a low-beam headlight beam, and a mask structure, wherein the mask structure defines a cut-off line that limits an amount of light above the cut-off line.

In some embodiments of the second apparatus, the projection optics includes a parabolic reflector that forms a high-beam headlight beam and an elliptical reflector and a mask structure that generates a low-beam headlight beam, wherein the mask structure defines a cut-off line that limits an amount of light above the cut-off line.

Some embodiments of the second apparatus further include: a set of one or more LEDs generates a second pump light; and a second plate having a phosphor therein operatively coupled to receive the second pump light and to emit wavelength-converted light from areas of the second plate illuminated by the second pump light, wherein the wavelength-converted light from the second plate propagates to the projection optics and is combined with the wavelength-converted light from the glass first plate.

In some embodiments of the second apparatus, the first pump-light source includes a first pump laser, and this second apparatus further includes: a set of one or more LEDs generates a second pump light; and a second plate having a phosphor therein operatively coupled to receive the second pump light beam and to emit wavelength-converted light from areas of the second plate illuminated by the second pump light beam, wherein the wavelength-converted light from the second plate is propagated to the projection optics and is combined with the wavelength-converted light from the glass first plate, wherein the first pump laser generates a hot spot in the projected headlight beam.

Some embodiments of the second apparatus further include: a MEMS assembly having at least a first two-dimensional scan mirror operatively coupled to the control logic to scan the first pump laser beam to selected areas of glass first plate to control a lateral extent of the headlight beam.

Some embodiments of the second apparatus further include: a MEMS assembly having only one two-dimensional scan mirror operatively coupled to the control logic to scan the first pump laser beam to selected areas of glass first plate to control a lateral extent of the headlight beam.

In some embodiments, the present invention provides a second method for automatically adjusting a spatial shape of a vehicle headlight beam as projected onto a scene. The second method includes: generating a first pump light; and using the first pump light, illuminating a first phosphor plate made of glass having a phosphor therein to pump the phosphor to emit wavelength-converted light from areas of the glass first phosphor plate illuminated by the first pump light; projecting, as a headlight beam toward the scene, the wavelength-converted light from the first phosphor plate and an unconverted portion of the first pump light; obtaining digital image data of the scene; using a LiDAR sensor configured to obtain a plurality of distance measurements of objects in the scene; and receiving and combining the image data and the plurality of distance measurements and, based on the combined image data and distance measurements, generating headlight-control data that is used to adjust the spatial shape of the headlight beam.

In some embodiments of the second method, the first pump light includes light from a first pump laser, and the method further includes: generating a second pump laser beam from a second pump laser; and directing the second pump laser beam onto a second phosphor plate having a phosphor therein to pump the phosphor in the second plate to emit wavelength-converted light from areas of the second phosphor plate illuminated by the second pump laser beam, wherein the wavelength-converted light from the second phosphor plate is combined with the wavelength-converted light from the glass first phosphor plate.

In some embodiments of the second method, the projecting includes reflecting light using a parabolic reflector.

In some embodiments of the second method, the projecting includes reflecting light using an elliptical reflector.

In some embodiments of the second method, the projecting includes reflecting light using an elliptical reflector configured to generate light of a low-beam headlight beam, and the method further includes masking the light of the low-beam headlight beam at a cut-off line that limits an amount of light above the cut-off line.

In some embodiments of the second method, the projecting includes reflecting light using a parabolic reflector that forms a high-beam headlight beam and using an elliptical reflector and a mask structure to form a low-beam headlight beam, wherein the mask structure defines a cut-off line that limits an amount of light above the cut-off line.

Some embodiments of the second method further include: generating a second pump light from a set of one or more LEDs; and directing the second pump light onto a second phosphor plate having a phosphor therein configured to receive the second pump light and to emit wavelength-converted light from areas of the second phosphor plate illuminated by the second pump light, wherein the wavelength-converted light from the second phosphor plate is combined with the wavelength-converted light from the first phosphor plate.

Some embodiments of the second method further include: generating a second pump light from a set of one or more LEDs; and directing the second pump light onto a second phosphor plate having a phosphor therein configured to receive the second pump light and to emit wavelength-converted light from areas of the second phosphor plate illuminated by the second pump light, wherein the wavelength-converted light from the second phosphor plate is combined with the wavelength-converted light from the first phosphor plate, wherein the first pump light includes a laser beam that generates a hot spot in the projected headlight beam.

In some embodiments of the second method, the first pump light includes a first laser beam, and the second method further includes controlling a micro-electrical-mechanical system (MEMS) assembly that includes at least a first two-dimensional scan mirror to scan the first pump laser beam to selected areas of first phosphor plate to control a lateral extent of the headlight beam.

Some embodiments of the second method further include: using a micro-electro-mechanical system (MEMS) assembly having only one two-dimensional scan mirror operatively coupled to the control logic to scan the first pump laser beam to selected areas of first phosphor plate to control a lateral extent of the headlight beam.

In some embodiments, the present invention provides a third apparatus (e.g., 1701 of FIG. 17A, 1702 of FIG. 17B, 1703 of FIG. 17C, 1801 of FIG. 18) for vehicle-headlight illumination and LiDAR scanning a scene. This third apparatus includes: a first MEMS scanner (e.g., 1713 of FIG. 17A, 1733 of FIG. 17B, 1733 of FIG. 17C, 1813 of FIG. 18) that includes a first two-dimensional scan mirror; a laser-phosphor smart headlight that includes: a blue-light laser (e.g., 1712 of FIG. 17A, 1712 of FIG. 17B, 1712 of FIG. 17C, 1812 of FIG. 18) that outputs a blue laser beam, and a target phosphor plate (e.g., 1714 of FIG. 17A, 1735 of FIG. 17B, 1737 of FIG. 17C, 1814 of FIG. 18); and a LiDAR laser system (e.g., 1714 of FIG. 17A, 1735 of FIG. 17B, 1737 of FIG. 17C, 1814 of FIG. 18) that includes: a pulsed infrared laser that outputs a pulsed infrared laser beam, and redirection optics, wherein the laser-phosphor smart headlight and the LiDAR laser system both use the first mirror of the first MEMS scanner to respectively reflect the blue laser beam of the blue-light laser onto the target phosphor plate and the pulsed infrared laser beam towards the redirection optics.

In some embodiments, the present invention provides a fourth apparatus for vehicle-headlight illumination and LiDAR scanning a scene. This third apparatus includes (see FIGS. 17B and 17C): a first MEMS scanner that includes a first mirror; a laser-phosphor smart headlight that includes: a blue-light laser that outputs a blue laser beam, and a target phosphor plate; and a LiDAR laser system that includes a pulsed infrared laser, wherein the laser-phosphor smart headlight and the LiDAR laser system both use the first mirror of the MEMS scanner to reflect respective laser beams of the blue-light laser along an optical path that impinges on the target phosphor plate and the pulsed infrared laser towards the scene.

In some embodiments, the present invention provides a fourth apparatus for vehicle-headlight illumination and LiDAR scanning a scene. This fourth apparatus includes (see FIG. 17A): a first MEMS scanner that includes a first mirror; a laser-phosphor smart headlight that includes: a pump laser that outputs a pump laser beam, and a target phosphor plate configured to receive the pump laser beam and convert a wavelength of the pump laser beam to a converted wavelength; and a LiDAR laser system that includes: a pulsed LiDAR laser that outputs a pulsed LiDAR laser beam to be scanned across the scene, and redirection optics, wherein the laser-phosphor smart headlight and the LiDAR laser system both use the first mirror of the first MEMS scanner to respectively reflect the pump laser beam of the pump laser along an optical path that impinges on the target phosphor plate and the pulsed LiDAR laser beam along an optical path that impinges on the redirection optics.

In some embodiments, the present invention provides a fifth apparatus for vehicle-headlight illumination and LiDAR scanning a scene. This fifth apparatus includes (see FIGS. 17A, 17B, and 17C): a first MEMS scanner that includes a first two-dimensional (2D) scanner mirror; a laser-phosphor smart headlight that includes: a pump laser that outputs a pump laser beam; and a target phosphor plate configured to receive the pump laser beam and convert a wavelength of the pump laser beam to a converted wavelength light; and a LiDAR laser system that includes: a pulsed LiDAR laser that outputs a pulsed LiDAR laser beam to be scanned across the scene, wherein the laser-phosphor smart headlight and the LiDAR laser system both use the first 2D scanner mirror to respectively reflect the pump laser beam of the pump laser along an optical path that impinges on the target phosphor plate and the pulsed LiDAR laser beam along an optical path towards the scene.

Some embodiments of the fifth embodiment further include LiDAR-beam redirection optics located along an optical path between the first 2D scanner mirror and the scene, wherein the redirection optics are configured to redirect the LiDAR laser beam to scan at least a portion of the scene illuminated by light propagating from the target phosphor plate.

Some embodiments of the fifth embodiment further include a LiDAR-beam redirection prism located along an optical path between the first 2D scanner mirror and the scene, wherein the redirection prism is configured to redirect the LiDAR laser beam to scan at least a portion of the scene illuminated by light propagating from the target phosphor plate.

Some embodiments of the fifth embodiment further include a LiDAR-beam redirection reflector system located along an optical path between the first 2D scanner mirror and the scene, wherein the redirection reflector system includes a plurality of reflectors configured to redirect the LiDAR laser beam to scan at least a portion of the scene illuminated by light propagating from the target phosphor plate.

Some embodiments of the fifth embodiment further include a projection lens located along an optical path between the first 2D scanner mirror and the scene; and a LiDAR-beam redirection reflector system located along the optical path between the first 2D scanner mirror and the scene, wherein the redirection reflector system includes a plurality of reflectors configured to redirect the LiDAR laser beam to scan at least a portion of the scene illuminated by light propagating from the projection lens.

In some embodiments of the fifth embodiment, the pump laser beam has a blue-color wavelength in the range of 420 nm to 480 nm inclusive, and wherein the converted wavelength light has a yellow color.

In some embodiments of the fifth embodiment, the pump laser beam has a blue-color wavelength of about 445 nm, and wherein the converted wavelength light has a yellow color.

In some embodiments of the fifth embodiment, the laser-phosphor smart headlight further includes: a second pump laser that outputs a second pump laser beam, and wherein the target phosphor plate assembly is configured to receive the second pump laser beam on a second area of the target phosphor plate assembly and convert a wavelength of the first pump laser beam to a converted-wavelength light; and a projection lens located along an optical path between the target phosphor plate assembly and the scene, wherein the projection lens is configured to form a headlight beam that includes a portion of unconverted light of the first pump laser beam and converted wavelength light from the first area of the target phosphor plate assembly and a portion of unconverted light of the second pump laser beam and converted wavelength light from the second area of the target phosphor plate assembly.

In some embodiments of the fifth embodiment, the laser-phosphor smart headlight further includes: a controller operably coupled to the first pump laser to modulate the first pump laser beam; and a projection lens located along an optical path between the target phosphor plate assembly and the scene, wherein the projection lens is configured to form a headlight beam that includes a portion of unconverted light of the first pump laser beam and converted wavelength light from the first area of the target phosphor plate assembly, and wherein the controller modulates the first pump laser beam to adjust a shape of the headlight beam.

In some embodiments of the fifth embodiment, the laser-phosphor smart headlight further includes: a controller operably coupled to the first pump laser to modulate the first pump laser beam; and a projection lens located along an optical path between the target phosphor plate assembly and the scene, wherein the projection lens is configured to form a headlight beam that includes a portion of unconverted light of the first pump laser beam and converted wavelength light from the first area of the target phosphor plate assembly, and wherein the controller modulates the first pump laser beam to form symbols in the headlight beam.

In some embodiments, the present invention provides a third method for vehicle-headlight illumination and LiDAR scanning of a scene. The third method includes: outputting a first pump laser beam from a first pump laser; using a first two-dimensional (2D) scanner mirror of a first MEMS scanner to scan the first pump laser beam across a first area of a surface of a target phosphor plate assembly containing a phosphor in order to pump the phosphor to convert a wavelength of the first pump laser beam to a converted wavelength light; using the first two-dimensional (2D) scanner mirror of a first MEMS scanner to also scan a pulsed LiDAR laser beam across the scene; and projecting converted wavelength light and an unconverted portion of the first pump laser beam as a headlight beam towards the scene.

Some embodiments of the third method further include: locating LiDAR-beam redirection optics along an optical path between the first 2D scanner mirror and the scene; and redirecting the LiDAR laser beam using the redirection optics to scan at least a portion of the scene illuminated by light projected from the target phosphor plate assembly.

Some embodiments of the third method further include: locating a redirection prism along an optical path between the first 2D scanner mirror and the scene; and redirecting the LiDAR laser beam using the redirection prism to scan at least a portion of the scene illuminated by light propagating from the target phosphor plate.

Some embodiments of the third method further include: locating a plurality of reflectors along an optical path between the first 2D scanner mirror and the scene; and redirecting the LiDAR laser beam using the plurality of reflectors to scan at least a portion of the scene illuminated by light propagating from the target phosphor plate.

Some embodiments of the third method further include: locating a projection lens along an optical path between the target phosphor plate assembly and the scene, wherein the projection lens is configured to form a headlight beam that includes a portion of unconverted light of the first pump laser beam and converted wavelength light from the first area of the target phosphor plate assembly; and locating a LiDAR-beam redirection reflector system along the optical path between the first 2D scanner mirror and the scene, wherein the redirection reflector system includes a plurality of reflectors configured to redirect the LiDAR laser beam to scan at least a portion of the scene illuminated by light propagating from the projection lens.

In some embodiments of the third method, the pump laser beam has a blue-color wavelength in the range of 420 nm to 480 nm inclusive, and wherein the converted wavelength light has a yellow color.

In some embodiments of the third method, the pump laser beam has a blue-color wavelength of about 445 nm, and wherein the converted wavelength light has a yellow color.

Some embodiments of the third method further include: outputting a second pump laser beam from a second pump laser; directing the second pump laser beam onto a second area of the target phosphor plate assembly and to pump phosphor in the second area to convert a wavelength of the second pump laser beam to a converted-wavelength light; and locating a projection lens along an optical path between the target phosphor plate assembly and the scene, wherein the projection lens is configured to form a headlight beam that includes a portion of unconverted light of the first pump laser beam and converted wavelength light from the first area of the target phosphor plate assembly and a portion of unconverted light of the second pump laser beam and converted wavelength light from the second area of the target phosphor plate assembly.

Some embodiments of the third method further include: controlling the first pump laser to modulate the first pump laser beam; and projecting a headlight beam that includes a portion of unconverted light of the first pump laser beam and converted wavelength light from the first area of the target phosphor plate assembly, wherein the controlling modulates the first pump laser beam to adjust a shape of the headlight beam.

Some embodiments of the third method further include: controlling the first pump laser to modulate the first pump laser beam; and projecting a headlight beam that includes a portion of unconverted light of the first pump laser beam and converted wavelength light from the first area of the target phosphor plate assembly, wherein the controlling modulates the first pump laser beam to form symbols in the headlight beam.

It is to be understood that the above description is intended to be illustrative, and not restrictive. Although numerous characteristics and advantages of various embodiments as described herein have been set forth in the foregoing description, together with details of the structure and function of various embodiments, many other embodiments and changes to details will be apparent to those of skill in the art upon reviewing the above description. The scope of the invention should be, therefore, determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on their objects.

1. (canceled)

2. An apparatus comprising:
a LiDAR device, the LiDAR device including:
a laser that outputs a pulsed LiDAR laser signal;
a DMD having a plurality of individually selectable mirrors arranged on a first major surface of the DMD;
first optics configured to capture light from an entire scene and to focus the captured light to a focal plane located at the first surface of the DMD;
a light detector;
a first light dump, wherein each respective one of the plurality of mirrors of the DMD is switchable to selectively reflect a respective portion of the captured light to one of a plurality of angles including a first angle that directs the reflected light toward the light detector and a second angle that directs the reflected light toward the first light dump;
a scan mirror configured to selectively point a narrow beam of the pulsed LiDAR laser signal to a plurality of successively selected XY angles; and
a controller operatively coupled to the DMD to control a tilt direction of each one of the plurality of mirrors of the DMD and operatively coupled to the scan mirror to control the successively selected XY angles toward which the narrow beam of the pulsed LiDAR laser is pointed,
wherein the controller controls the plurality of individually selectable mirrors of the DMD to direct light from those mirrors at one or more selected XY locations on the DMD corresponding to the plurality of successively selected XY angles to the light detector and to direct light from others of the plurality of individually selectable mirrors toward the first light dump.

3. (canceled)

4. An apparatus comprising:
a LiDAR device, the LiDAR device including:
a laser that outputs a pulsed LiDAR laser signal;
a DMD having a plurality of individually selectable mirrors arranged on a first major surface of the DMD;
first optics configured to capture light from an entire scene and to focus the captured light to a focal plane located at the first surface of the DMD;
a light detector;
a first light dump, wherein each respective one of the plurality of mirrors of the DMD is switchable to selectively reflect a respective portion of the captured light to one of a plurality of angles including a first angle that directs the reflected light toward the light detector and a second angle that directs the reflected light toward the first light dump;
a second light dump;
a scan mirror configured to selectively point a narrow beam of the pulsed LiDAR laser signal toward a plurality of successively selected XY angles;
a controller operatively coupled to the DMD to control selectable tilt directions of each one of the plurality of mirrors of the DMD and operatively coupled to the scan mirror to control the successively selected XY angles toward which the narrow beam of the pulsed LiDAR laser is pointed,
wherein the plurality of individually selectable mirrors of the DMD are configured to direct light from those mirrors corresponding to the plurality of successively selected XY angles to the light detector and to direct light from others of the plurality of individually selectable mirrors toward the first light dump; and
a scene-illumination source of light operatively configured to direct scene-illumination light onto the DMD,
wherein the plurality of individually selectable mirrors of the DMD is configured to direct scene-illumination light from those mirrors corresponding to a plurality of simultaneously selected XY angles toward the first optics,
wherein the first optics configured to output selected portions of the scene-illumination light for output as a headlight beam, and
wherein the plurality of individually selectable mirrors of the DMD is configured to direct light from others of the plurality of individually selectable mirrors toward the second light dump.

5. The apparatus of claim 4, wherein the selectable tilt directions of each one of the plurality of mirrors of the DMD includes a first tilt angle relative to the first major surface of the DMD and a second tilt angle relative to the first major surface of the DMD, and wherein the first tilt angle directs light from the scene toward the light detector and the second tilt angle directs light from the scene toward the first light dump.

6. The apparatus of claim 4, wherein the selectable tilt directions of each one of the plurality of mirrors of the DMD includes a first tilt angle relative to the first major surface of the DMD and a second tilt angle relative to the first major surface of the DMD, and wherein the first tilt angle directs light from the scene-illumination source of light toward the scene and the second tilt angle directs light from the scene-illumination source of light toward the second light dump.

7. The apparatus of claim 4, wherein the scene-illumination source of light is pulsed such that the pulses from the scene-illumination source of light are interleaved in time with the pulsed LiDAR laser signal.

8. The apparatus of claim 4, wherein:
the selectable tilt directions of each one of the plurality of mirrors of the DMD includes a first tilt angle relative to the first major surface of the DMD and a second tilt angle relative to the first major surface of the DMD, and wherein the first tilt angle directs light from the scene toward the light detector and the second tilt angle directs light from the scene toward the first light dump, and wherein the first tilt angle is a positive angle relative to a reference line on the first major surface of the DMD and the second tilt angle is a negative angle relative to the reference line on the first major surface of the DMD.

9. An apparatus comprising:
a LiDAR device, the LiDAR device including:
a laser that outputs a pulsed LiDAR laser signal;
a DMD having a plurality of individually selectable mirrors arranged on a first major surface of the DMD;
first optics configured to capture light from an entire scene and to focus the captured light to a focal plane located at the first surface of the DMD;
a light detector;
a first light dump, wherein each respective one of the plurality of mirrors of the DMD is switchable to selectively reflect a respective portion of the captured light to one of a plurality of angles including a first angle that directs the reflected light toward the light detector and a second angle that directs the reflected light toward the first light dump;
a controller operatively coupled to the DMD to control a tilt direction of each one of the plurality of mirrors of the DMD;
an optical-spread element configured to spread the pulsed LiDAR laser signal into a wide-angle beam that is spread across the entire scene, and
wherein the controller controls the plurality of individually selectable mirrors of the DMD to direct light from those mirrors successively selected at one or more selected XY locations on the DMD corresponding to the plurality of successively selected XY angles to the light detector and to direct light from others of the plurality of individually selectable mirrors toward the first light dump.

10. An apparatus comprising:
a LiDAR device, the LiDAR device including:
a laser that outputs a pulsed LiDAR laser signal;
a DMD having a plurality of individually selectable mirrors arranged on a first major surface of the DMD;
first optics configured to capture light from an entire scene and to focus the captured light to a focal plane located at the first surface of the DMD;
a light detector;
a first light dump, wherein each respective one of the plurality of mirrors of the DMD is switchable to selectively reflect a respective portion of the captured light to one of a plurality of angles including a first angle that directs the reflected light toward the light detector and a second angle that directs the reflected light toward the first light dump; and
a controller operatively coupled to the DMD to control a tilt direction of each one of the plurality of mirrors of the DMD,
wherein the pulsed LiDAR laser signal is a wide-angle beam that is spread across the entire scene, and
wherein the controller controls the plurality of individually selectable mirrors of the DMD to direct light from those mirrors successively selected at one or more selected XY locations on the DMD corresponding to the plurality of successively selected XY angles to the light detector, and to direct light from others of the plurality of individually selectable mirrors toward the first light dump, and wherein how many of the mirrors that are selected to direct light to the light detector is variable based on signal strength.

11. (canceled)

12. A method comprising:
outputting a pulsed LiDAR laser signal from a laser toward a scene;
collecting and focusing reflected light from the pulsed LiDAR laser signal onto a focal plane located at a first surface of a DMD having a plurality of individually selectable mirrors arranged on the first major surface of the DMD;
controlling a first selected subset of plurality of individually selectable mirrors to reflect a selected portion of the collected and focused reflected light from the pulsed LiDAR laser signal onto a light detector;
controlling a second selected subset of plurality of individually selectable mirrors to reflect a remaining portion of the collected and focused reflected light from the pulsed LiDAR laser signal onto a first light dump;
controlling a scan mirror to selectively point a narrow beam of the pulsed LiDAR laser signal to a plurality of successively selected XY angles; and
controlling a tilt direction of each one of the plurality of mirrors of the to direct light from those mirrors at one or more selected XY locations on the DMD corresponding to the plurality of successively selected XY angles to the light detector, and to direct light from others of the plurality of individually selectable mirrors toward the first light dump.

13. (canceled)

14. A method comprising:
outputting a pulsed LiDAR laser signal from a laser toward a scene;
collecting and focusing reflected light from the pulsed LiDAR laser signal onto a focal plane located at a first surface of a DMD having a plurality of individually selectable mirrors arranged on the first major surface of the DMD;
controlling a first selected subset of plurality of individually selectable mirrors to reflect a selected portion of the collected and focused reflected light from the pulsed LiDAR laser signal onto a light detector;
controlling a second selected subset of plurality of individually selectable mirrors to reflect a remaining portion of the collected and focused reflected light from the pulsed LiDAR laser signal onto a first light dump;
controlling a scan mirror to selectively point a narrow beam of the pulsed LiDAR laser signal toward a plurality of successively selected XY angles;
controlling a tilt direction of each one of the plurality of mirrors of the to direct light from those mirrors at one or more selected XY locations on the DMD corresponding to the plurality of successively selected XY angles to the light detector, and to direct light from others of the plurality of individually selectable mirrors toward the first light dump;
directing scene-illumination light onto the DMD;
controlling the plurality of individually selectable mirrors of the DMD to direct scene-illumination light from those mirrors corresponding to a plurality of simultaneously selected XY angles toward the scene; and
controlling selected ones of the DMD output selected portions of the scene-illumination light as a headlight beam, and controlling others of the plurality of individually selectable mirrors do direct other portions of the scene-illumination light toward a second light dump.

15. The method of claim 14, wherein the selectable tilt directions of each one of the plurality of mirrors of the DMD includes a first tilt angle relative to the first major surface of the DMD and a second tilt angle relative to the first major surface of the DMD, and wherein the first tilt angle directs light from the scene toward the light detector and the second tilt angle directs light from the scene toward the first light dump.

16. The method of claim 14, wherein the selectable tilt directions of each one of the plurality of mirrors of the DMD includes a first tilt angle relative to the first major surface of the DMD and a second tilt angle relative to the first major surface of the DMD, and wherein the first tilt angle directs light from the scene-illumination source of light toward the scene and the second tilt angle directs light from the scene-illumination source of light toward the second light dump.

17. The method of claim 14, wherein the scene-illumination source of light is pulsed such that the pulses from the scene-illumination source of light are interleaved in time with the pulsed LiDAR laser signal.

18. The method of claim 14, wherein the selectable tilt directions of each one of the plurality of mirrors of the DMD includes a first tilt angle relative to the first major surface of the DMD and a second tilt angle relative to the first major surface of the DMD, and wherein the first tilt angle directs light from the scene toward the light detector and the second tilt angle directs light from the scene toward the first light dump, and wherein the first tilt angle is a positive angle relative to a reference line on the first major surface of the DMD and the second tilt angle is a negative angle relative to the reference line on the first major surface of the DMD.

19. A method comprising:
outputting a pulsed LiDAR laser signal from a laser toward a scene;
collecting and focusing reflected light from the pulsed LiDAR laser signal onto a focal plane located at a first surface of a DMD having a plurality of individually selectable mirrors arranged on the first major surface of the DMD;
controlling a first selected subset of plurality of individually selectable mirrors to reflect a selected portion of the collected and focused reflected light from the pulsed LiDAR laser signal onto a light detector;
controlling a second selected subset of plurality of individually selectable mirrors to reflect a remaining portion of the collected and focused reflected light from the pulsed LiDAR laser signal onto a first light dump;
spreading the pulsed LiDAR laser signal into a wide-angle beam that is spread across the entire scene, and
controlling a tilt direction of each one of the plurality of mirrors of the DMD to direct light from those mirrors successively selected at one or more selected XY locations on the DMD corresponding to the plurality of successively selected XY angles to the light detector and to direct light from others of the plurality of individually selectable mirrors toward the first light dump.

20. A method comprising:
outputting a pulsed LiDAR laser signal from a laser toward a scene;
collecting and focusing reflected light from the pulsed LiDAR laser signal onto a focal plane located at a first surface of a DMD having a plurality of individually selectable mirrors arranged on the first major surface of the DMD;
controlling a first selected subset of plurality of individually selectable mirrors to reflect a selected portion of the collected and focused reflected light from the pulsed LiDAR laser signal onto a light detector;
controlling a second selected subset of plurality of individually selectable mirrors to reflect a remaining portion of the collected and focused reflected light from the pulsed LiDAR laser signal onto a first light dump;
spreading the pulsed LiDAR laser signal into a wide-angle beam that is spread across the entire scene, and
controlling a tilt direction of each one of the plurality of mirrors of the DMD to direct light from those mirrors successively selected at one or more selected XY locations on the DMD corresponding to the plurality of successively selected XY angles to the light detector and to direct light from others of the plurality of individually selectable mirrors toward the first light dump, and wherein how many of the mirrors that are selected to direct light to the light detector is variable based on signal strength.

21.-60. (canceled)
